(19) United States
(12) Patent Application Publication
(10) Pub. No.: US 2011/0207621 A1
(43) Pub. Date: Aug. 25, 2011

(54) Assays Based on Liquid Flow over Arrays

(75) Inventors: Jean I. Montagu, Brookline, MA (US); Herman Deweerd, Bedford, MA (US); Natalia A. Rodionova, Framingham, MA (US); Nathan Tyburczy, Billerica, MA (US)

(73) Assignee: AVANTRA BIOSCIENCES CORPORATION, Boston, MA (US)

(21) Appl. No.: 12/918,757

(22) PCT Filed: Feb. 20, 2009
(86) PCT No.: PCT/US09/34777

§ 371 Date: Mar. 22, 2011

Related U.S. Application Data
(60) Provisional application No. 61/030,276, filed on Feb. 21, 2008.

(51) Int. Cl. C40B 30/04; C40B 60/12; C40B 30/00; C40B 50/00; F04B 43/00

(52) U.S. Cl. 506/9; 506/39; 506/7; 506/23; 417/53

(57) ABSTRACT

Flow-through assay reaction chamber (6) of cassette has back and forth liquid mixing in narrow gap (G) over array of capture agent (S), with net flow advance to waste confinement (19), produced by reversible pumps (3 or 12), operable with rolling diaphragm action with at least limited elastic recovery that advance sample or buffer liquids through conditioning paths (4A, 8, 8′, 9, 14, 15, 15′) before reaching the reaction chamber (6). A single pump produces accurate flow control, liquid conditioning, e.g., liquefying dry reagent from internal surfaces of flow-dividing material (14a, 15A, 15A′, e.g. open cell foam or frit), heating (4A), and air bubble removal (8, 8′, 9), as well as replenishment of reagent while accomplishing mixing within the flow-through reaction chamber (6). Lower viscosity buffer liquid is arranged to propel higher viscosity reagent, the flow-dividing storage material preserving reagent concentration. A blister pack (11) acts as a reversible pump (12) in producing accurate forward and backward flows with the net flow advance. Cascaded bubble traps (8, 9) on the cassette render the system tolerant of minor pumping error during cassette priming.

### TECHNICAL FIELD

This disclosure relates to the improved construction and operation of micro-fluidic devices and especially to such devices constructed to perform assays such as biological assays. It relates especially to cassettes based on fluid flow in low aspect ratio chambers and in small channels at low Reynolds Number, i.e. NRe less than one and preferably much lower. In respect of biological assays, it relates to obtaining consistent results with cassettes that store dried detection reagents such as antibodies or antigens, dried label reagent such as fluorescent compounds and liquid buffer in form used to hydrate the dried materials. It also relates to pumping, agitating and transporting fluids effectively to and through a reaction chamber of a cassette; to handling fluids with different viscosities or diffusion coefficients; and to techniques for minimizing sample size and the amount of reagent required to perform a cassette-based assay.

### BACKGROUND

Biological and chemical assays have been developed for detecting the presence of compounds of interest in samples. In the biomedical field, methods for detecting the presence of proteins, peptides, antigens, antibodies, and nucleotide sequences are utilized, for example, in diagnosing medical conditions, determining predisposition of patients to disease, and performing DNA fingerprinting. In general, biological and chemical assays are based on exposing an unknown sample to one or more known reagents and monitoring the progress or measuring the outcome of any reaction. There is currently a high level of interest in the development of rapid, easy to use, real-time, on-demand multiplex biomarker analysis, and especially, biomarker analysis with respect to analytes present at low abundances in blood serum or plasma.

An effective system for conducting such assays within a cassette is described in our patent applications entitled “ASSAYS BASED ON LIQUID FLOW OVER ARRAYS”, publications US 2006/0275852 A1 and WO 2006/132666 A1. Better and more extensive use of this system, and of other assay systems, can be achieved with improvement in cassette construction and assay techniques. For instance, there remains a need to better address assays that employ liquids containing low abundance analytes. There is need for cassettes which enable reduction in the consumed quantity of analyte-containing liquid and of costly reagents stored in the cassettes. There is need to reduce the cost of manufacture of cassettes. There is need to achieve improved spot-to-spot consistency in the results obtained from an array of spots of capture reagent provided on a bio-chip incorporated in the reaction chamber of an assay cassette.

Consideration of the features of a typical assay helps to understand these and other needs of biological and chemical assays.

The Assaying Process

As an example, a typical protein assay employs two-proteins having binding affinity in the same space within a fluid. Each protein exists in a specific concentration within the volume of fluid. The proteins bind and separate as a function of their concentrations, their time together and their ability to bind to one another. The bound fraction (normally called the “complexed” fraction) is defined by the “binding coefficient” specific to each pair of proteins present. This is not an instantaneous process and it reaches an asymptotic value. Normally, to avoid requiring disadvantageously lengthy assays, the binding process is terminated before completion but with a time determined by the sensitivity desired, typically the assays being conducted for a time lying in the approximately linear region of the time-coupling relationship curve.

One molecule, the capture protein, which may be an antibody or antigen, is typically bound on a solid such as in spots located on a coated glass support surface. The other molecule, the analyte, the concentration of which is to be defined, is within a fluid that is caused to flow over the capture surface within a reaction chamber, or “RC”. The analyte may be an antigen or an antibody, respectively. Typically the fluid is blood serum or blood plasma, but it may also be cell lysate, liquid containing cells, other body fluids, etc.

The goal of the assay is to count the number of complexed molecules and derive the molecular density of the analyte in a sample being analyzed. This is possible as the molecular density of the capture protein is known.

When performed using flows in a cassette, the flow rate is extremely slow (defined by a Reynolds Number NRe less than one, typically about 1/100) well within the laminar flow mode. Molecular motion may be mostly due to diffusion. The degree of molecular binding is a function of molecular mobility as well as molecular density.

Flow rates in the assay are controlled by the respective pumps and the diffusion is controlled by the fluid temperature. The diffusion coefficient of serum or plasma rises 30% as temperature is raised from 25 to 37 deg. C. In most cases it is desirable to hold the temperature of the reaction chamber at 37+/−1 deg. C. This may contribute a mobility variability/error of the order of 1.5% if no calibration or compensation is implemented.

When the temperature of a fluid is raised it outgases in the form of micro-bubbles that cluster and can block small or large areas of the reaction chamber of a cassette, causing havoc with the assay. A bubble trap is employed to capture such bubbles before they enter the reaction chamber. In a preferred case, all fluids are brought to temperature before entering the bubble trap to ensure adequate release and capture of dissolved gas.

In the preferred bubble trap, bubbles separate from the fluid by buoyancy. To enable this action, in the cassette of our previous patent applications, the cassette is normally processed in a near-vertical position.

Following the capture phase, which may last approximately 10 minutes, a second fluid with “detection molecules” (sometimes called “secondary protein” or “detection ligand”) is pushed to displace and replace the flow of the analyte reagent flowing through the reaction chamber, or it may displace wash liquid that may have been introduced after stopping the flow of analyte liquid. The molecules of this detection reagent, which may be another antibody or antigen, are of a type selected so that they can bind only to the captured molecules of analyte. This flow may last approximately 10 minutes. This assay is referred to as a “sandwich assay” as the analyte molecules are captured between two layers of molecules, the capture and the detection molecules.

The molecules of detection reagent are stored in a dry form within the cassette in the detection ligand chamber and must be hydrated (liquefied) to become active and capable of being transported. This hydration can take place during an initial interval while the analyte is being pushed through the reaction chamber.

In order to render the doubly complexed set of molecules visible, a detection tag (label), e.g., a molecule with a fluorescent dye, e.g., Cy3, Alexa 532 or R-phicogripheryn, is made to flow over and bind to the captured detection molecules.

The tag (label) reagent is also stored in a dry form, within the detection tag chamber, and must be hydrated to become active and capable of being transported. This hydration also can take place during the initial interval while the analyte is pushed through the reaction chamber.

From the foregoing it is seen that the process of exposing reacting molecules in a liquid environment for binding or coupling necessitates that the associating molecules come into extremely close proximity. Agitation of fluid is generally recognized to facilitate binding and reduce time required to perform an assay, but within microfluidic cassettes there has been difficulty in achieving the desired degree of agitation and flow consistency in a practical, reliable, low cost way.

Examples of Prior Work

Three basic platforms are in common use in the field to perform biological assays: multi-well plates, microscope slide-based spotted array assays and cassette-based spotted array assays.

In order to shorten the duration of assays performed within multi-well plates, it is common to employ mechanical agitators. Numerous models have been in use for decades such as the “3D Shakers” and “3D Agitators” available in the Fisher Scientific catalogue. These are not suitable for agitation of fluids in cassette chambers with small gaps where surface tension forces are very large as compared to dynamic accelerations that can be imparted on volumes of fluids found in multi-well or micro-well plates.

With respect to microscope slide-based spotted micro-array assays, these are frequently performed “on the bench” with the help of gaskets and simple tooling such as available from Grace Biolab. Bench techniques are time-consuming and call for highly skilled technicians to ensure repeatable results.

The need for more reproducible assays and proper mixing of reagents has brought forth a number of automated hybridization systems designed to mechanize biological spotted array-based assays performed on microscope slides. One such is described in U.S. Pat. No. 5,958,760 (Freeman—MRC London) and another in U.S. Pat. No. 6,093,574 (Ventana), U.S. Pat. No. 5,654,199 (Ventana) and U.S. Pat. No. 6,045,759 (Ventana). Again U.S. Pat. No. 5,922,591 (Affymetrix) proposes mixing carried out through the use of piezoelectric elements, electrophoretic methods, electromagnetically induced vibration, gas bubble agitation or physical mixing by pumping fluids back and forth into and out of the hybridization chamber in communication with external adjoining containers or chambers. Similar agitation methods are described in Stapleton U.S. Pat. No. 5,436,129 as well as U.S. Pat. Nos. 5,451,500 and 5,922,604. However, these methods depend on the use of relatively complex equipment, in some cases require the use of specially designed microscope slides or other substrates, and in other ways are not considered optimal for present purposes.

U.S. Pat. Applications 2005/0019898, 2004/0109793, 20004/0037739, 2002/0192701, as well as U.S. Pat. No. 6,637,463 (BioMicro) describe mixing in a low volume, low aspect ratio micro-fluidic chamber. Two or more mixing bladders formed at opposite ends of a micro-fluidic reaction chamber are inflated and deflated in reciprocating fashion to cause inward and outward deflection of discrete regions of the chamber wall to mix fluid within the chamber. Such multiple mixing bladders are actuated by air or another gas, or by liquid such as water, pumped in and out of the bladders, employing a pump which may be located remotely from the bladders of the micro-fluidic chamber. In an alternative embodiment, mixing is generated by applying alternating mechanical forces to a surface of a flexible chamber-forming device. This technique has a degree of complexity and features that are undesirable.

Self-Contained Microarray-Based Cassettes

Microarray-based cassettes represent an extension of automation in which the spotted array is held in an enclosure and analytes and detection and label reagents stored in the cassettes are brought into contact with the capture reagents bound to the array. The cassettes are desired to be more reliable than other techniques and require the minimum level of skill to perform an assay. They are frequently used in diagnostic testing as well as in analysis of DNA samples. Spots of capture reagent in micro-arrays may be formed of various large bio-molecules, such as proteins, or smaller molecules such as drugs, co-factors, signaling molecules, peptides or oligonucleotides as well as DNA or RNA segments; cultured cells as well as cell lysates may also be deposited or grown onto micro-arrays. As an example, if it is desired to detect the presence of a particular antibody in a patient sample, the sample is exposed to a micro-array of spots formed of associated antigen having complementary binding sites (epitopes). The occurrence of coupling between the sample and a known antigen in a particular spot then indicates the presence, and perhaps the quantity, of the antibody in the sample.

Micro-array based cassettes offer great potential for performing complex quantitative analyses of samples by carrying out multiple detection reactions simultaneously. However, there is difficulty in obtaining consistent, high quality results, with high sensitivity, which makes detection of low abundance proteins difficult. The need for higher quality multiplexed micro-array based cassette processing is particularly pronounced because individual micro-array cassettes are expensive and only limited quantities of the sample used in the reactions may be available, making it particularly important to obtain good results consistently.

Though it is desirable to consume minimal quantities of sample, however, when small quantities of sample fluid are dispensed to flow through a reaction chamber of a cassette, the fluid layer is very thin. This leads to the possibility that, if insufficient flow or mixing is provided, the sample fluid will become locally depleted of a particular protein over some spots binding that protein. As a target analyte is depleted, reaction kinetics slow, resulting in a lower signal. Thus, non uniform signal may be obtained from a number of identical spots exposed to the liquid within a spotted array cassette. This is an especially great problem for low-abundance proteins.

It is desirable that assays be performed in a low-volume chamber, since low volumes allow for higher concentration of reactants that are in limited supply, but adequate means need to be found to maintain kinetic rate high to produce more reaction products.

As a general proposition, the desirability of using agitation or mixing to promote chemical reactions in cassettes has of course long been known. The problem has been to find suitable and efficient means in the environment of mixing in cassette flows at extremely low Reynolds numbers in small volume passages and reaction chambers, under the practical conditions of useful assays.

Conceptually, the desirability of agitation or mixing in cassettes is referred to for instance in U.S. Pat. No. 5,798,215 (BioCircuits). “To assist in homogeneous dispersal of the various reagents of a particular assay or protocol in the sample and other liquid mediums flowing through the device, an agitation means may be provided in at least one of the main and side reagent areas and/or the incubation area. The agitation means serves to provide sufficient fluid flow so that dry reagent present in the vicinity of the agitation means is efficiently hydrated and homogeneously distributed throughout the fluid. Agitation means includes airflow, shaking, ultrasonic techniques, suction techniques, e.g. where reagent is dehydrated onto a porous membrane and fluid is sucked through the membrane resulting in hydrated reagent, and mechanical means, preferably mechanical mixing means. Suitable mechanical mixing means include mixing means fabricated from magnetic and paramagnetic materials, and may take diverse forms, including propellers, pins, dumbbells, balls, wires, perforated sheets, discs with fins and the like. In a preferred embodiment, the agitation means is an impeller device. Where the material from which the mixing means is fabricated is magnetic or paramagnetic, agitation is conveniently accomplished by applying a moving magnetic field above or below the device, or alternatively, by moving the device through a stationary magnetic field. The rate and/or timing of mixing may be controlled as needed to cause the desired level of agitation.” That patent shows an impeller located within a cassette and rotated clock-wise and counter clockwise to agitate fluids, a technique we do not regard as suitable for cassettes and assays of types, sensitivity, and consistency we wish to achieve.

A number of other approaches have been proposed to meet the recognized need of mixing reagent fluids in micro-array based cassettes in Biotechnology at Low Reynolds Numbers—Biophysics Journal, Vol. 71-December 1996 pp 3430-3441. See also the Cambridge Monograph on Applied and Computational Mathematics: “The Mathematical Foundations of Mixing, the Linked Twist Map as a Paradigm Applications Micro to Macro, Fluids to Solids”; Starman, Ottono, Wiggins, Cambridge University Press.

The approaches proposed include filling the reaction chamber of a cassette with suitable reagent and ensuring the presence of an air bubble and slowly tumbling the cassette (Affymetrix U.S. Pat. No. 5,945,334). This approach demands a suitably large reaction chamber gap, 1.8 mm recommended, so that the bubble will overcome surface tension forces and move under changing acceleration such as by tumbling. This method simulates mechanical agitation commonly encountered with assays performed in multi-well plates, and is not suitable at much smaller dimensions.

The approaches proposed have also included providing angled, diverting sets of ridges or other formations in bounding surface of flow channels, for instance alternating herring-bone patterns.

Reagent mixing in low aspect ratio reaction chambers or within micro-channels with a gap typically less than 1 mm and as low as 0.035 mm is suggested by flowing the various analytes through the chambers or channels. This is exemplified by the cassette technique of Theranos where a pump mechanism causes a one directional flow through micro-channels, U.S. Pat. applications 2006/0264779, 2006/0264780, 2006/0264781, 2006/0264782, and 2006/0264783.

In a similar way the cassette assay process of Zyomix flows all reagents through an arrangement of reaction chambers in a one-direction flow, described in U.S. Pat. No. 6,630,358.

Fluid mixing via fluid recirculation by external actuation is shown in U.S. Pat. No. 6,767,706 (Quake).

Cassettes for spotted array-based biological assays where reagents flow through an ultra low volume reaction chamber, however, have exhibited a low level of repeatability. Efforts to correct this shortcoming have promoted the use of additional assays to be used for reference/calibration and to correct all values. Such a technique is disclosed in U.S. Pat. Application 2006/0210984 of Lambert. In order to compensate for improper reagent mixing within the reaction chamber of a cassette a calibration assay is added to quantify and recalibrate all errors due to improper mixing of reagents. The added assays add to cost, sample consumption, etc., and leave much to be desired.

In our view, none of the prior proposals for cassette-based assays adequately deals with the anisotropic diffusion properties of non-Newtonian fluids such as blood, serum, plasma, or protein solutions nor recognizes the need for energetic mixing such fluids demand. There remains a need for a system that provides a more efficient way to maintain uniform concentration in a reaction chamber when working with non-Newtonian fluids as in low volume reaction chamber of cassettes or in fluidization chambers where stored dry reagents such as proteins or antibodies, detection proteins, etc. are held prior to being transported to the reaction chamber.

The lack of uniform or predictable mixing is treated by J. McCann et al (Non Uniform Flow Behavior in Parallel Plate Flow Chamber Alter Endothelial Cell Responses—Annals of Biomedical Eng., Vol. 33 No. 3-March 2005-pp 328-336) and (Inadvertent Variations in Fluid Flow Across a Parallel Plate Flow Chamber Results in Non-Uniform Gene Expression—2003 Summer Bioengineering Conference, June 25-29, Sonesta Beach resort in Key Biscayne, Fla.) but no solution is offered.

Further, we realize that none of the above cassette techniques adequately considers transport and mixing of fluids having different viscosity coefficients and more specifically do not address the condition where a low viscosity fluid enters a chamber already filled with a fluid of higher viscosity and it is desired to push along the higher viscosity liquid while preserving its concentration, i.e., without dilution by the pushing fluid.

Though apparently not fully appreciated by designers of cassettes, we realize the significance of, and provide means to deal with, mis-matched viscosities commonly encountered when a reaction chamber of a cassette is first filled with serum and the serum is later displaced with buffer liquid. Typically, healthy human blood serum at 37 deg. C., for instance, has a viscosity of 1.20 mPas while water or buffer has a viscosity of 0.8 mPas. Low viscosity buffer fluid, introduced to propel or mix with a higher viscosity fluid such as the serum creates a channel proceeding through the higher viscosity fluid while diffusing minimally. (This condition is exemplified by the flow of the Gulf Stream through the Atlantic Ocean). Pumping the buffer back and forth tends only to move the buffer as a column through the higher viscosity pool. A similar condition is encountered when buffer liquid is pushed into a chamber to displace concentrated liquefied detection reagent such as antibodies stored in a chamber.

Storage Media

In respect of storage of biological material prior to use, the employment of absorbing media such as cloth, membrane, foams or frits to hold and release biological material is well documented—Design and Application of Hydrophilic polyurethanes, T. Thomson; Technomics publishing, 2000 and Thompson U.S. Pat. No. 6,617,014. Other techniques create foam where one of the components is a molecule to be released upon wetting, U.S. Pat. No. 5,766,520, or is freeze-dried to form a support for vaccine and injected, U.S. Pat. No. 7,135,180.

A common use of foams in assay processing is known as Lateral Flow Membranes typically using nitrocellulose membranes for their ability to capture proteins as well as permit/promote the flow of analyte material over them. A common use is the dip stick pregnancy test such as offered by Inverness Medical Corporation.

### SUMMARY OF THE DISCLOSURE

Features that will be described are novel per se and act in novel combinations as shown to enable highly consistent quantitative multiplex assays at relatively low cost.

In one aspect, features disclosed relate to the technique of storing desiccated biological molecules or similar agents on a material filling the transverse cross-section of a substantial length of a storage passage within a cassette and systems, method and protocol to release the molecules and form a homogeneous segment of fluid in plug-like flow. This involves the selection or creation of a material e.g., a porous material, typically a hydrophilic foam or frit, such that biological molecules can be dried and preserved on it in a releasable manner, i.e. not permanently captured, and so selecting, sizing and disposing the material in a storage passage, that in the presence of a liquefying agent, a displacing flow of a different viscosity, due to the flow-dividing effect of the selected material, produces plug-like flow of the liquefied agent. This contributes to uniformity of reconstituted liquid reagent delivered to the reaction chamber of the cassette. Advantageously, the material, e.g. foam or frit, is preformed into sets of segments sized to tightly fit in respective sections of a storage passage to ensure that liquid must flow through the material. For a particular assay that has been selected, a set of the segments may receive selected reagents for the assay, and the set is dried and stored, ready to be installed in respective storage passages in the cassette when required. Advantageously, the flow is subjected to forward and backward oscillations of unequal nature during its forward progress out of the storage passage.

In a related aspect of the disclosure, there is provided a cassette having a reaction chamber constructed to conduct a reaction related to an assay, the cassette including buffer liquid storage, a buffer liquid displacement pump for displacing liquids at Reynolds number less than 1 through a passage system, the passage system including a buffer delivery passage for buffer liquid displaced by the pump, a reagent storage passage having extended length relative to a dimension of its transverse cross-section and capable of storing a liquid reagent of viscosity relatively higher than the viscosity of the buffer liquid, and a relatively small flow cross-section reagent delivery passage leading from the reagent storage passage to the reaction chamber, the buffer delivery passage arranged to deliver displaced buffer liquid into the reagent storage passage, wherein a substantial majority of the length of the reagent storage passage is filled with porous material or a multiplicity of substantially parallel flow sub-channels, the porous material or sub-channels providing a multiplicity of paths along the reagent storage passage of transverse cross-sections that are small relative to the over-all transverse cross-section of the reagent storage passage and distributed across its cross-section and along its length to establish, in response to the pump's displacement, plug-like flow of the relatively higher viscosity reagent liquid from the reagent storage passage into the reagent delivery passage.

Implementations of this aspect of the disclosure may have one or more of the following features.

The cassette includes a positive displacement pump arranged to push liquid through the multiplicity of paths defined by the porous material or the sub-channels within the reagent storage passage.

The surface of the porous material or the sub-channels is hydrophilic.

The surface of the porous material or sub-channels is a hydrophilic surface for supporting reagent material dried thereon, and has a releasable property for the reagent when contacted with liquid, a dried layer of reagent material disposed on the hydrophilic surface, exposed to contact with buffer liquid flowing into the reagent passage to enable the reagent material to be liquefied in situ, to create the relatively viscous reagent liquid that is subject to the plug-like flow.

The size of pores of the porous material is between about 5 to 200 micron, in one case the size of the pores being selected from the group of materials comprising material having a nominal pore size of 30 micron, with variation plus or minus 50%, and material having a nominal pore size of 100 micron, with variation plus or minus 20%.

The reagent storage passage has rectangular transverse cross-section and porous material of sheet-form foam or frit closely fits the transverse cross-section over substantially more than half of the length of the reagent storage passage, in some cases the reagent storage passage is a channel of substantially constant transverse cross-section, of length at least about 60 mm and channel width and depth of about 2 mm and 0.6 mm, respectively.

The porous material comprises hydrophilic frit formed of polyethylene.

The porous material comprises hydrophilic melamine foam.

The porous material comprises hydrophilic polyurethane foam.

The porous material comprises porous nitrocellulose in treated state that enables release of deposited bio-material when contacted with liquid, in some cases the treated state comprising a coating on the nitrocellulose of a mediating substance such as a blocker protein.

The porous material comprises hydrophilic polystyrene foam in treated state that enables release of deposited bio-material when contacted with liquid.

The reagent storage passage of the cassette is defined by a multiplicity of parallel sub-channels, each having transverse cross-section dimensions less than 1 mm, in some cases dimensions less than about 0.5 mm, or in the range of between about 0.5 mm and 0.01 mm.

The sub-channels are formed by a molded or extruded resin bearing a hydrophilic surface coating.

The reagent comprises a detection reagent, in some cases the detection reagent being an antibody or antigen.

The reagent comprises a label reagent, in some cases the label reagent includes a fluorescent dye.

Flow dividing material, e.g., open-cell foam or frit, in a storage channel, has a length in the direction of flow at least 10 times the width of the material, and the width of the material is at least twice the thickness of the material, preferably the material is of sheet-form of thickness less than 1 mm. In a preferred form a segment of the material is more than 40 mm in length, more than 1.5 mm in width and about 0.6 mm in thickness.

A method is provided of delivering liquid reagent to a reaction chamber by displacing reagent liquid from a storage passage by a buffer liquid of viscosity that is low relative to the viscosity of the liquid reagent, comprising providing a cassette according the first-mentioned aspect of the disclosure, which may have one or more of the related features just described, in which either the reagent has been provided in liquid form to the cassette, or has been stored in the cassette in dried form and subsequently liquefied to provide the reagent liquid, and operating the buffer pump to pump buffer liquid into the porous material or multiplicity of sub-channels and establishing plug-like flow of the relatively higher viscosity reagent liquid from the reagent storage passage into the reagent delivery passage.

According to another aspect of the disclosure, a method is provided of delivering liquid reagent via a reagent delivery passage to a reaction chamber by displacing reagent liquid from a storage passage by a buffer liquid of viscosity that is low relative to the viscosity of the liquid reagent, comprising providing a cassette in which the reagent has been stored in the cassette in dried form as a dried layer on a hydrophilic surface of a porous material within the reagent storage passage, or on a hydrophilic surface of a multiplicity of substantially parallel sub-channels forming the reagent storage passage, initially operating a buffer displacement pump in manner to introduce buffer liquid into the reagent storage chamber to liquefy the reagent, the resulting reagent liquid being of substantially higher-viscosity than the buffer liquid remaining stored in the cassette, and subsequently operating the buffer pump to pump buffer liquid into the porous material or multiplicity of sub channels and establishing plug-like flow of the relatively higher viscosity reagent liquid from the reagent storage passage into the reagent delivery passage for supply to the assay reaction chamber.

Implementations of this aspect may have the dried reagent layer in the form of detection or label bio-materials, and may employ backward and forward oscillations of the liquid with net forward advance, to effectively provide flow to the reaction chamber.

According to another aspect of the disclosure, a cassette is provided having a liquid storage, pumping and passage system and a reaction chamber, the cassette constructed to conduct a reaction related to an assay by flow of liquids with Reynolds number less than 1 through the system and over a capture surface within the reaction chamber, the cassette constructed to be stored with air-filled passages prior to use, but, after initial entry of analyte-containing liquid into the reaction chamber, constructed to exclude air from reaching the reaction chamber until completion of reactions of the assay, the storage, pumping and passage system including: an analyte chamber constructed to receive an analyte-containing liquid,

an analyte displacement pump for displacing analyte-containing liquid through the system and reaction chamber, a first buoyancy bubble trap arranged to be filled by displaced analyte-containing liquid, and a passage leading from the first bubble trap to the reaction chamber; the storage, pumping and passage system also including: pre-filled buffer liquid storage, a buffer liquid displacement pump for displacing liquids through the system and the reaction chamber, the buffer liquid displacement pump having a predetermined range of flow volume error, a buffer delivery passage for buffer liquid displaced by the buffer liquid displacement pump, a reagent storage passage containing a dried reagent and capable of storing the reagent in liquid form when it is liquefied, a reagent delivery passage leading from the reagent storage passage for flow to the reaction chamber, the buffer delivery passage arranged to deliver displaced buffer liquid into the reagent passage and, alternatively, through a wash passage for flow to the reaction chamber, and a second buoyancy bubble trap arranged to be filled by displaced buffer liquid, the reagent storage passage adapted to be filled by the buffer pump by activation for a predetermined pumping volume that results in leaving an indeterminate volume of un-displaced air in the buffer delivery passage of volume within a range determined by the predetermined range of flow volume error of the buffer displacement pump, the second buoyancy bubble trap sized to hold the maximum volume of air that can remain in the reagent storage passage due to the buffer pump operating for the predetermined pumping volume at the lowest flow volume within its predetermined range of flow volume error together with air released by liquid flowing through the second bubble trap, the discharge of the second bubble trap connected to flow through the first bubble trap and thence to the reaction chamber, the first bubble trap sized to hold residual air residing between the first and second bubble traps together with air released from the flow of liquids through it.

Implementations of this aspect of the disclosure may have one or more of the following features.

The flow from the wash passage also flows through the second bubble trap, thence through the first bubble trap to the reaction chamber.

A passage is associated with a detector for the air-liquid interface of liquid entering the passage, enabling an external pump and associated control unit responsive to the detector to fill that passage to a predetermined point.

A passage associated with a detector is arranged to fill the second bubble trap by operating the buffer displacement pump over a predetermined pumping volume that results in leaving an indeterminate volume of un-displaced air upstream of the first bubble trap, within a range determined by the predetermined range of flow volume error of the buffer displacement pump, the first bubble trap sized to receive and store said un-displaced air.

There are at least two passages connectible to be filled by the buffer pump by respective operations of the pump, leaving an indeterminate amount of air in each of the respective passages within the volumetric range based on the predetermined range of flow volume error of the pump, each of these passages arranged to enable its flow to pass through the second bubble trap, the second bubble trap sized to hold the maximum volume of air that may remain within each passage connected to it together with air from liquids passing through the bubble trap. In some cases the at least two passages merge into a common passage leading to the second bubble trap without passing through a valve.

The first bubble trap has an air holding volume of about 10 uL, and the second bubble trap has an air holding volume of about 50 uL.

The buffer displacement pump comprises a blister pack containing buffer liquid, a surface of the pouch being deflectable by an actuator external of the cassette to progressively displace liquid from the blister pack.

The analyte displacement pump comprises a rolling diaphragm pump.

According to another aspect of the disclosure, a method is provided of conducting an assay employing the cassette of any of the foregoing descriptions, in which the cassette has storage passages for both a detection reagent and a label reagent.

A method is provided of conducting an assay with a cassette having the components indicated below, with reference to FIGS. 2-5 for illustration, and operated substantially according to the following protocol:

1. Insert analyte liquid in analyte chamber 2 via septum 1

2. Close valves 18 & 17 (wash passage 37 and tag reagent chamber 15)

3. Open valve 16 (detection reagent chamber 14)

4. Operate buffer pump 12 (rotating stepper motor, depressing piston of buffer pump 12) to

5. Impale pouch 11 on awl (pyramid) 30 to release buffer liquid

6. Continue to operate buffer pump 12 (depressing piston and compressing pouch 11) to fill detection reagent chamber 14 until

7. Opto-sensor 13 triggers

8. Close valve 16

9. Open valve 17

10. Operate buffer pump 12 predetermined number of stepper motor steps to fill tag reagent chamber 15 and slightly beyond within error tolerance Stop.

11. Close valve 17

12. Open valve 18

13. Operate buffer pump 12 predetermined number of stepper motor steps to fill wash passage 37 and bubble trap 8 and slightly beyond within error tolerance. Stop

14. Close valve 18

15. Operate analyte pump 3 to fill bubble trap 9 until Opto-sensor 5 triggers

16. Continue to operate analyte pump 3 to flow analyte liquid through reaction chamber 6 per protocol.

17. Open valve 18 and operate buffer pump 12 to wash reaction chamber 6 with buffer liquid per protocol

18. Close valve 18

19. Open valve 16 and operate buffer pump 12 to flow detection reagent through reaction chamber 6 per protocol

20. Close valve 16

21. Open valve 18 and operate buffer pump 12 to wash reaction chamber 6 with buffer liquid per protocol

22. Close valve 18

23. Open valve 17 and operate buffer pump 12 to flow tag reagent through reaction chamber 6 per protocol

24. Close valve 17

25. Open valve 18 and operate buffer pump 12 to wash reaction chamber 6 per protocol

26. Prepare chip for imaging.

27. Image the biochip through the window of the reaction chamber 6 and send data to computer for analysis

28. THE END.

According to another aspect of the disclosure, the cassette or method of any of the preceding descriptions has a buffer pump in the form of a blister pack filled with buffer fluid, the blister pack having a cover and a volume-defining blister body, the body capable of progressive collapse between a driving piston external of the cassette and an anvil surface to produce a positive liquid displacement pumping action to force liquid forward into the passage system.

Implementations of this aspect of the disclosure may have one or more of the following features.

The cover is adhered and sealed about a piercing device (awl) disposed on the anvil surface, and capable of being deformed to be pierced for releasing liquid to a channel associated with the piercing device.

The cover is a metal foil of soft aluminum of thickness of about 0.001 inch.

The body of the blister pack is capable of elastic recovery upon retraction of the piston sufficient to produce negative liquid pumping action to draw liquid back from the passage system.

The body of the blister pack is defined by a draw-formed sheet that comprises a layer of aluminum, the blister pack subject to permanent deformation when compressed to reduce the blister pack volume and displace liquid from the blister pack forward into the passage system of the cassette in a forward pumping action, for a backward pumping action for a limited distance following forward pumping action, the residual elastic recovery of the permanently deformed aluminum wall of the blister body to a less deformed position permitted by progressive retraction of the piston serving as the driving force to increase the volume of the blister pack by drawing liquid back into the blister pack, in some cases the blister pack having a volume of about 2 ml and the elastic recovery permitted by progressive retraction of the actuator produces an increase in the volume of the previously deformed blister pack by at least 3 ul.

According to another aspect of the disclosure, a method of pumping liquid within a cassette employs a deformable metal blister pack and includes progressively compressing and permanently deforming the body of the blister pack with an actuator to displace liquid forward, and periodically reversing the movement of the actuator and allowing limited elastic recovery of the permanently deformed blister body to maintain contact with the rearward moving actuator, the increase in volume of the deformed blister pack drawing liquid back into the blister pack. In some instances, this blister pack is constructed with any of the previously described features of blister packs.

According to another aspect of the disclosure, a system for conducting an assay is provided employing a cassette having a liquid displacement pump actuated by an external actuator according to a predetermined automatic pumping protocol, the cassette having a liquid passage system and a reaction chamber having inlet and discharge ends associated respectively with inlet and discharge passages, the cassette constructed to conduct a reaction related to an assay by pumped flow of liquids with Reynolds number less than 1 through the passage system and over a capture surface within the reaction chamber, through the discharge passage to a waste receptacle from which there is no return, wherein the control system responsive to the pumping protocol drives the pump in a cyclic operation with forward pumping and backward pumping phases in repeating cycles, the forward pumping phase arranged to produce flow through the reaction chamber out the discharge end, through the discharge passage to the waste receptacle and the backward pumping phase arranged to produce backward flow withdrawing liquid from the inlet end of the reaction chamber and the discharge passage, the net flow per cycle according to the predetermined protocol being in the forward direction out of the discharge end for substantial discharge of liquid to the waste receptacle, and replenishing flow of the liquid to which the capture surface is exposed.

Implementations of this aspect of the disclosure may have one or more of the following features.

Typically, for producing flow of reagent over the capture surface, the pump comprises a deformable container having a wall that is resilient within at least a limited elastic range, the container arranged to be compressed by motion of an external actuator and, for backward pumping for a limited distance following forward pumping, the recovery of the wall within its elastic range, to a less deformed position as permitted by retraction of the actuator, serving to increase the volume of the container to draw liquid backward into the container, resulting in drawing liquid backward through the inlet of the reaction chamber. In implementations of this feature, the container may comprise a blister pack, the body of the blister pack (which may be defined by a formed sheet that comprise a layer of aluminum) subject to permanent deformation by compression of the body by the external actuator to reduce the volume of the blister pack and displace liquid forward from it. In implementations of any of these features the container may contain a pre-packaged buffer liquid.

The pump is a rolling diaphragm pump associated with a storage chamber. In implementations of this feature the storage chamber may be an analyte chamber, the analyte chamber associated with a septum for insertion of analyte fluid into the chamber as a preliminary step prior to conducting the assay with the cassette.

An upwardly extending discharge passage at the discharge end of the reaction chamber terminates at a point of gravity fall of discharge into a waste chamber, the discharge passage sized to contain at least a volume equal to the volume of liquid drawn backward through the inlet during the rearward flow phase of a pumping cycle, so that the backward flow occurs without exposing the reaction chamber to air.

The reaction chamber and total back flow per cycle determined by the pumping protocol are of substantially the same volume. In implementations the volume may be about 4 ul.

The reaction chamber is defined by a capture surface and opposed window spaced apart by a flow gap of between about 50 and 300 micron, the width and length of the capture surface and opposed window being substantially greater than the flow gap, the inlet passage and the discharge passage being of substantially different flow cross-section profile from that of the reaction chamber. In implementations the depth of the gap between the capture surface and opposed window may be of the order of 100 micron, their width being about 4 mm and their length about 12 mm.

In another aspect, a pumping control system is provided for causing flow of liquid at Reynolds number less that 1 through a reaction chamber to progressively expose an assay capture surface to the liquid, wherein the control system is responsive to a predetermined pumping protocol to drive a pump in a cyclic operation with forward and backward pumping phases in repeating cycles, the forward pumping phase arranged to produce flow through the reaction chamber and out a discharge end, through a discharge passage to waste confinement and the backward pumping phase arranged to produce backward flow withdrawing liquid from an inlet end of the reaction chamber and from the discharge passage, the net flow per cycle according to the predetermined protocol being in the forward direction out of the discharge end for discharge of liquid to the waste confinement, and replenishing fresh liquid to the reaction chamber.

Preferred implementations of this aspect have one or more of the following features. The pump is located on a cassette that encloses the reaction chamber and preferably the waste confinement is a waste receptacle enclosed within the cassette.

The predetermined pumping protocol provides a forward flow to backward flow volume ratio in the range of about 3/1 to 3/2. In implementation of this feature, the ratio may be about 2/1. In some implementations the flows in both directions may be at about the same volumetric flow rates, the forward flow phase lasting longer, e.g., about twice as long, as the backward flow phase. In some implementations the flow rates are different, e.g., the forward flow phase having about twice the volumetric flow rate of the backward flow phase.

The cycles of operation include cycles having dwell phases during which the pump does not pump liquid. The control system for producing the set of operations comprising the back and forth missing with net flow advance includes a machine readable medium having instructions stored therein which, when executed, cause the system to perform this set of operations in accordance with the pumping protocol, preferably the system including at least one linear pump actuator driven by a stepper motor to perform the operations, preferably the linear pump actuator being positioned to drive a pump within an assay cassette the pump preferably operable with a rolling diaphragm action with at least limited elastic recovery.

The cyclically operating pump propels the liquid through a conditioning region while advancing the liquid to the reaction chamber. Preferably: the conditioning region includes provisions for heat exchange with the pumped liquid, preferably when adapted for biological assay the heat exchange regulated to heat the liquid to about 37° C.; the conditioning region includes a system for removing gas bubbles from the pumped liquid, for conditioning the liquid is propelled through a region in which a substance is exposed to the pumped liquid, preferably the substance is a dried substance distributed through the body of flow-dividing open cell foam or frit through which the pumped liquid is directed preferably the open cell foam or frit filling a reagent storage passage of length in the flow direction greater than at least 10 times the largest transverse dimension of the storage passage, preferably the reagent storage passage being of rectangular cross-section transverse to the direction of flow and porous material of sheet-form open cell foam or frit fills the cross section of the passage over more than half of the length of the reagent storage passage, preferably the storage passage has an open volume (plenum) at each end into which liquid displaced through the porous material enters.

A method is provided of conducting an assay employing the cassette according to this aspect of the disclosure, which may employ one or more of any of the above-enumerated additional features; in important cases the method may be conducted in manner to cause liquid containing analyte to move in forward and backward directions over the capture surface with net forward flow to the waste receptacle; in some cases the capture surface may comprise an array of replicate spots of a given capture reagent arranged transversely to the direction of flow over the capture surface.

The method is conducted so that, following pumping of liquid containing analyte to flow over the capture surface in the reaction chamber, the pumping is stopped and a buffer pump is actuated to force buffer liquid to displace a reagent liquid in a reagent storage passage to cause reagent liquid to flow through the reaction chamber. In important instances the buffer pump is actuated to cause liquid containing reagent to move in forward and backward directions in the reagent storage passage to produce mixing while causing net forward flow of liquid through a reagent delivery passage and the reaction chamber to the waste receptacle.

Advantageously, the method may be conducted with a cassette having a reagent storage passage containing porous material that provides a multiplicity of interlaced flow paths along the reagent storage passage, the flow paths being open to one another and of transverse cross-sections that are small relative to the over-all transverse cross-section of the reagent storage passage and distributed across its transverse cross-section and along its length; in important instances the porous material comprises open cell foam or frit, which may have the pore sizes mentioned above. In important cases the method is conducted with a cassette in which a desiccated reagent is distributed through the porous material. And in important cases the presence of the porous material is effective to produce substantially a plug-like flow of reagent liquid from the reagent storage passage into a reagent delivery passage in response to forward pumping of the buffer liquid.

According to another aspect of the disclosure, the mixing effect of the open cell foam or frit is dominant: in an assay cassette having flows limited to Reynolds number less than 1, a mixing flow channel extends in a general direction and is connected to supply reagent to a reaction chamber, the channel filled for a substantial length with a three-dimensional mass of open cell foam or frit selected to cause fluid flowing in the channel to split into a large multiplicity of relatively small flows along differing interlaced flow paths, the paths having flow components transverse to the general direction of the channel along with flow components in the direction of the flow channel, the individual flow paths varying in direction relative to one another and being open to interchange with each other effective to produce a substantially chaotic mixing effect upon liquid flowing into and through the open cell foam or frit material, the output of the channel arranged to supply flow of the thus-mixed liquid to the reaction chamber.

Implementations of this aspect of the disclosure may have one or more of the following features.

Within the reaction chamber, there is a solid capture surface carrying an array of replicate spots of capture reagent for capturing a reagent carried in the flow from the channel.

The surface within the foam or frit is hydrophilic and a desiccated biological agent is supported on the surface, exposed to be hydrated by flow of liquid through the foam or frit. The channel is connected to receive flow of a buffer liquid of viscosity substantially less than the viscosity of reagent exiting the foam or frit material.

The size of pores of the open cell foam or frit material is between about 5 to 200 micron, in one case the size of the pores being selected from the group of materials comprising material having a nominal pore size of 30 micron, with variation plus or minus 50%, and material having a nominal pore size of 100 micron, with variation plus or minus 20%.

A mixing flow channel has a transverse cross-section and porous material of sheet-form foam or frit closely fits the transverse cross-section over substantially more than half of the length of the channel, in some cases the channel is of substantially constant transverse cross-section, of length at least about 60 mm and channel width and depth of about 2 mm and 0.6 mm, respectively.

The details of one or more implementations of the aspects and features of the disclosure are set forth in the accompanying drawings and the description below. Other features, objects, and advantages will be apparent from the description and drawings, and from the claims.

### BRIEF DESCRIPTION OF THE DRAWINGS

FIG. 1 is a symbolic representation of a form of a cassette;

FIGS. 1′ and 1″ are symbolic representations of other forms of a cassette;

FIG. 2 is a plan view of the front of the base molding of a cassette implementing the form of cassette of FIG. 1;

FIG. 2A is a magnified portion of FIG. 2;

FIG. 2B is a diagrammatic perspective view of the narrow flow gap, reaction chamber of FIGS. 1 and 2 in which vectors indicate forward (positive) and rearward (negative) volumetric displacement of liquid through the reaction chamber occurring in a cycle of forward and backward movement;

FIG. 3 is a plan view of the back of the base molding of the cassette of FIG. 2;

FIG. 4 is an isometric view of the base molding of the cassette of FIG. 2;

FIG. 5 is an exploded view of the assembly of the cassette of FIG. 2;

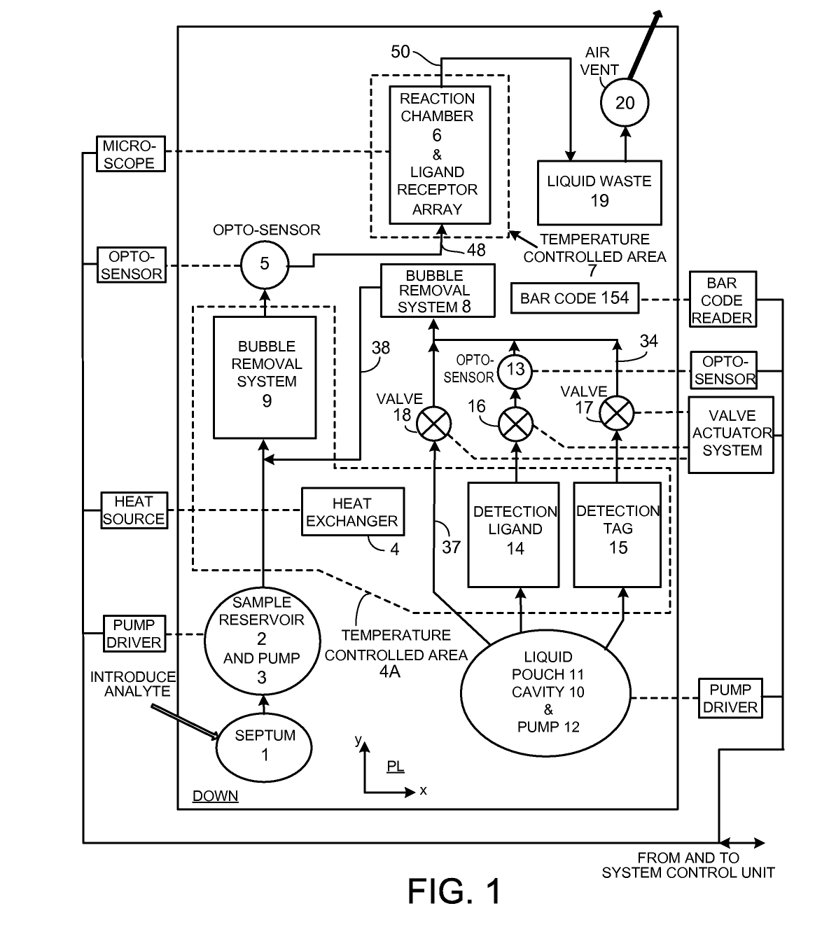

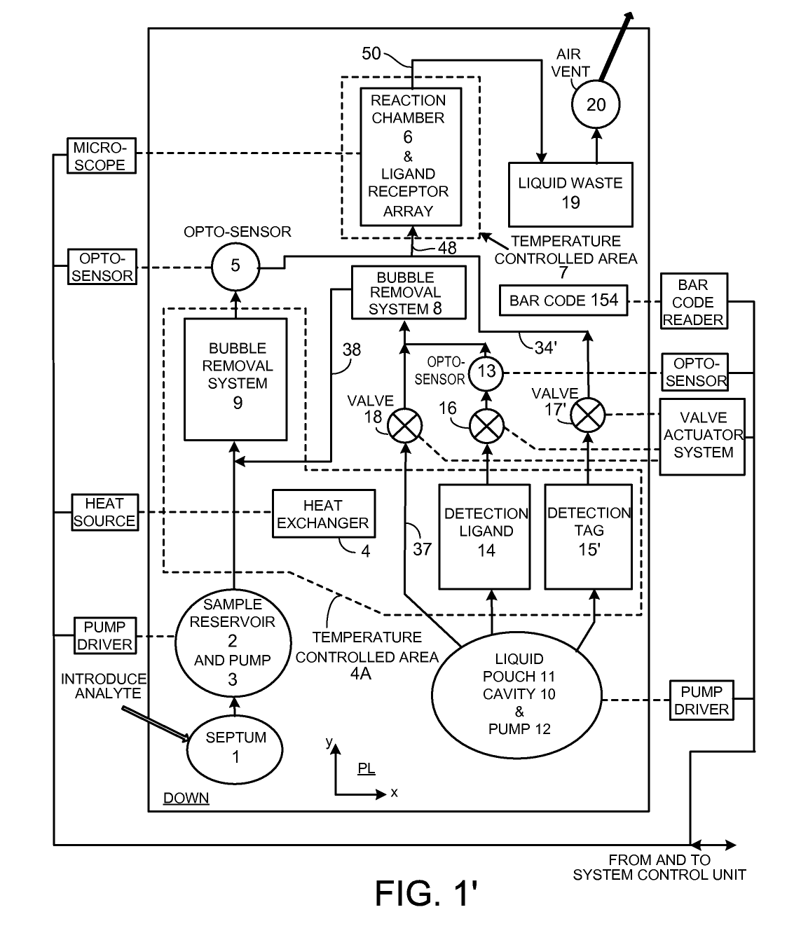

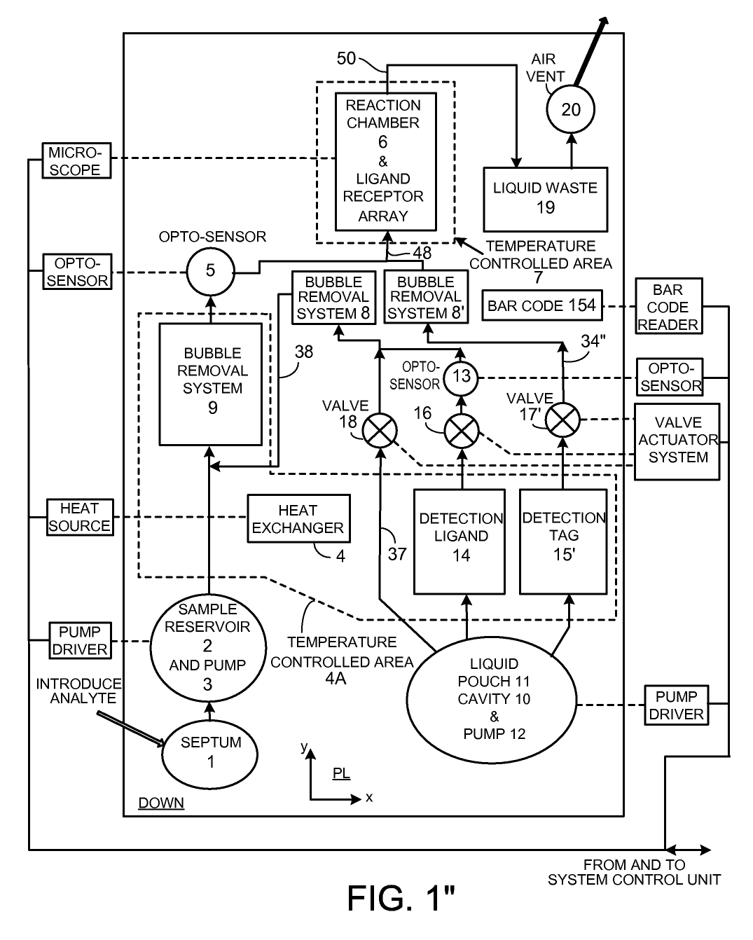

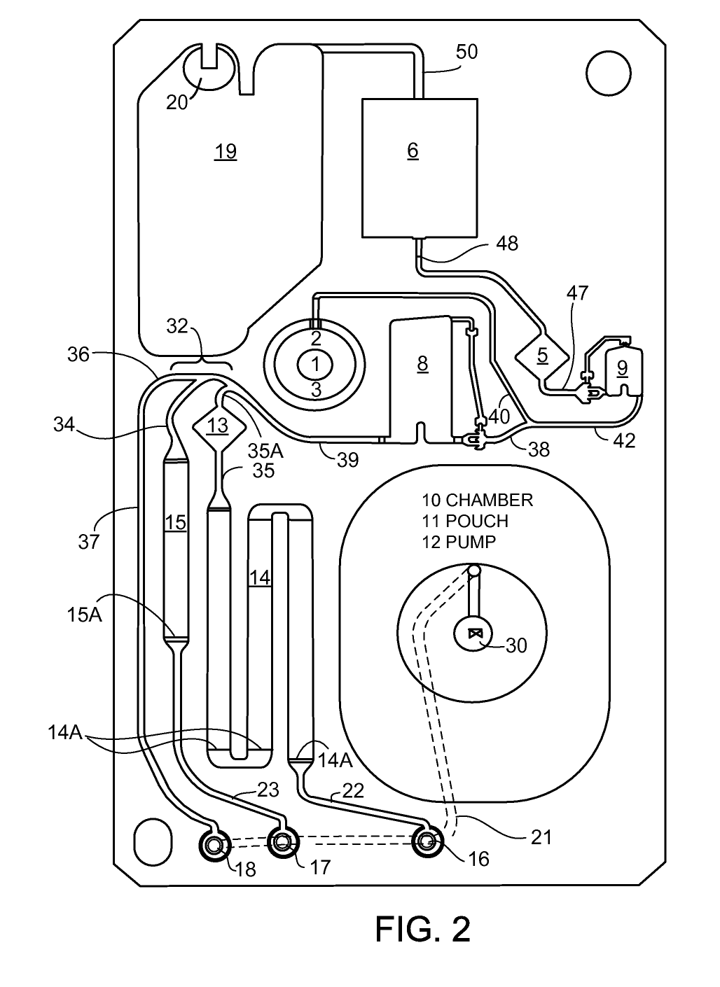

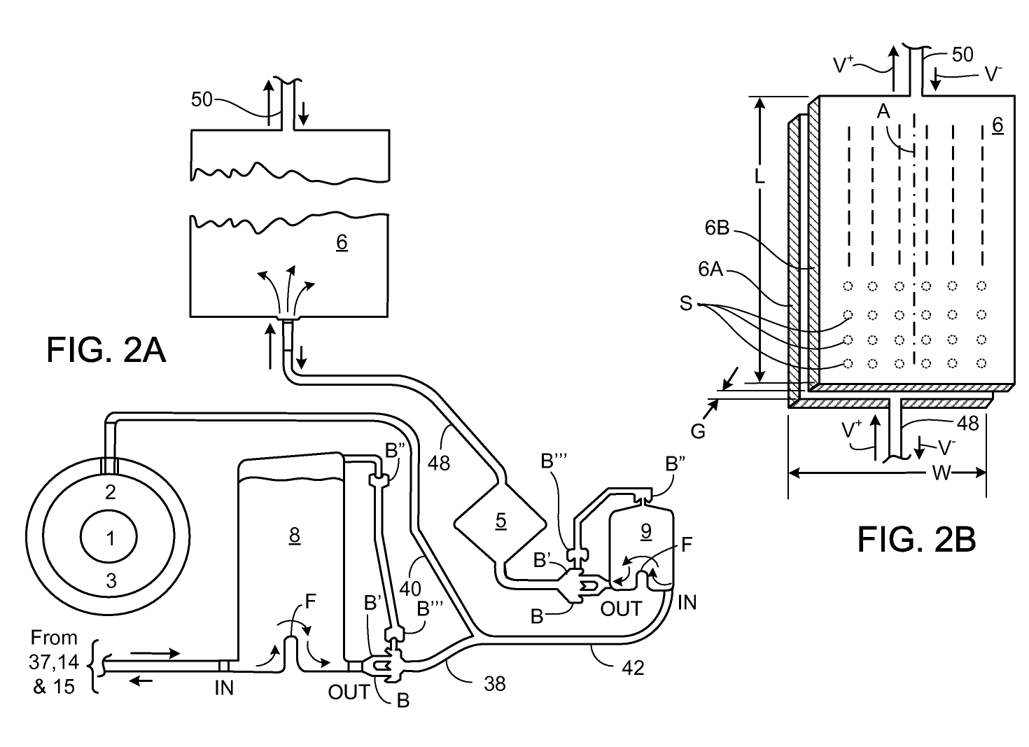

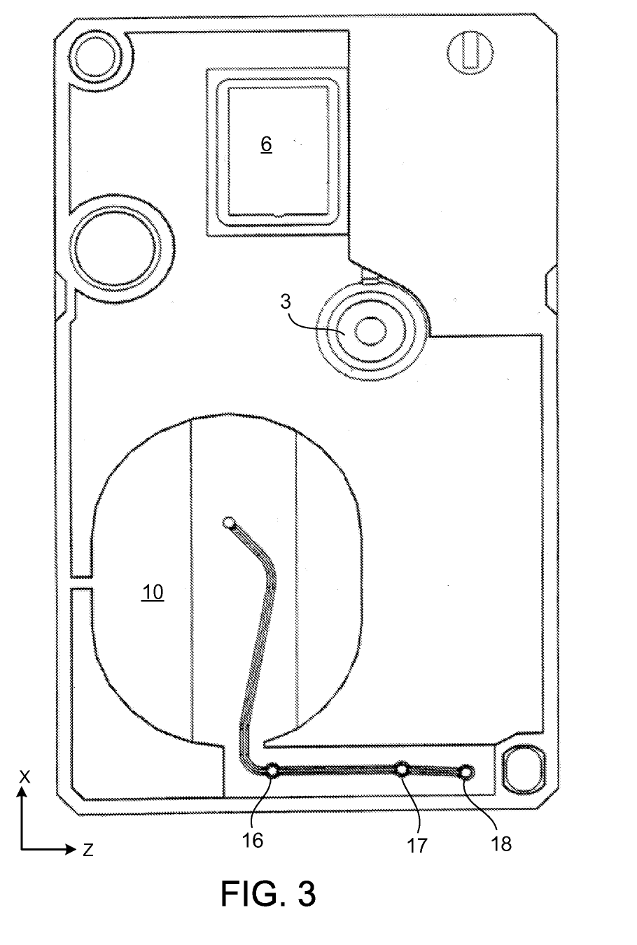

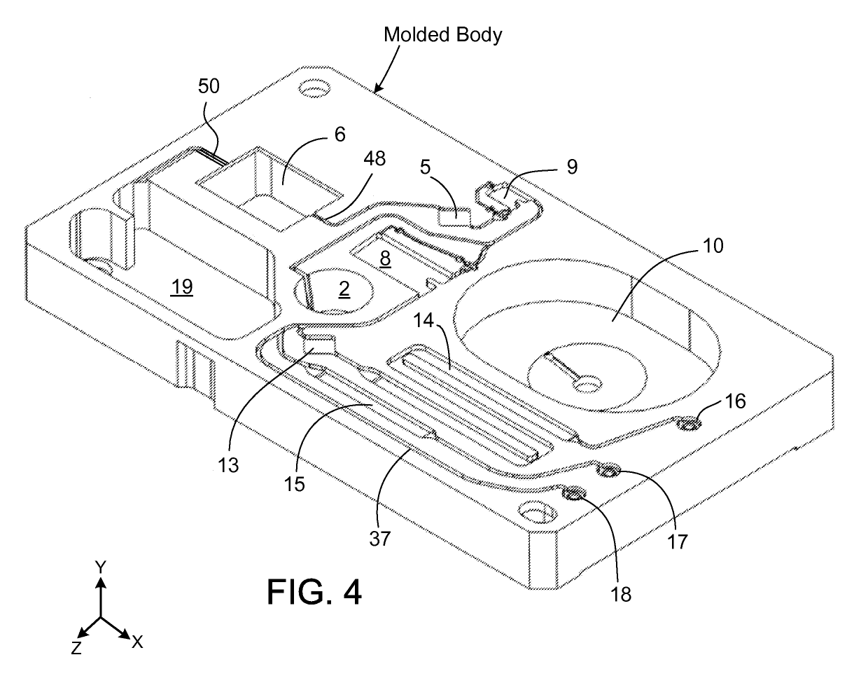

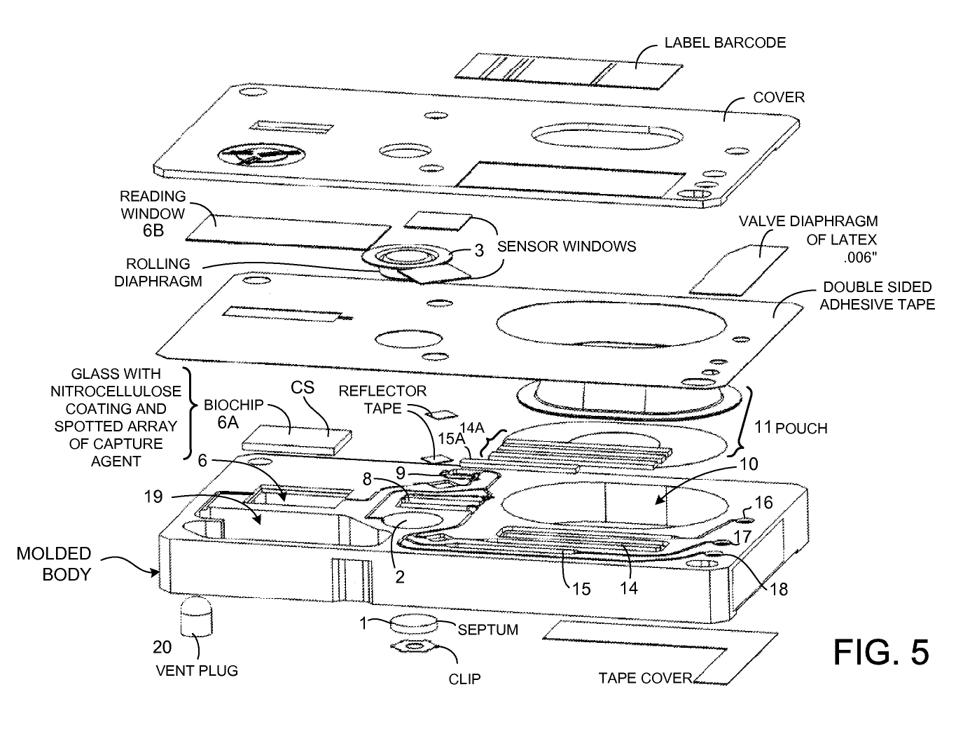

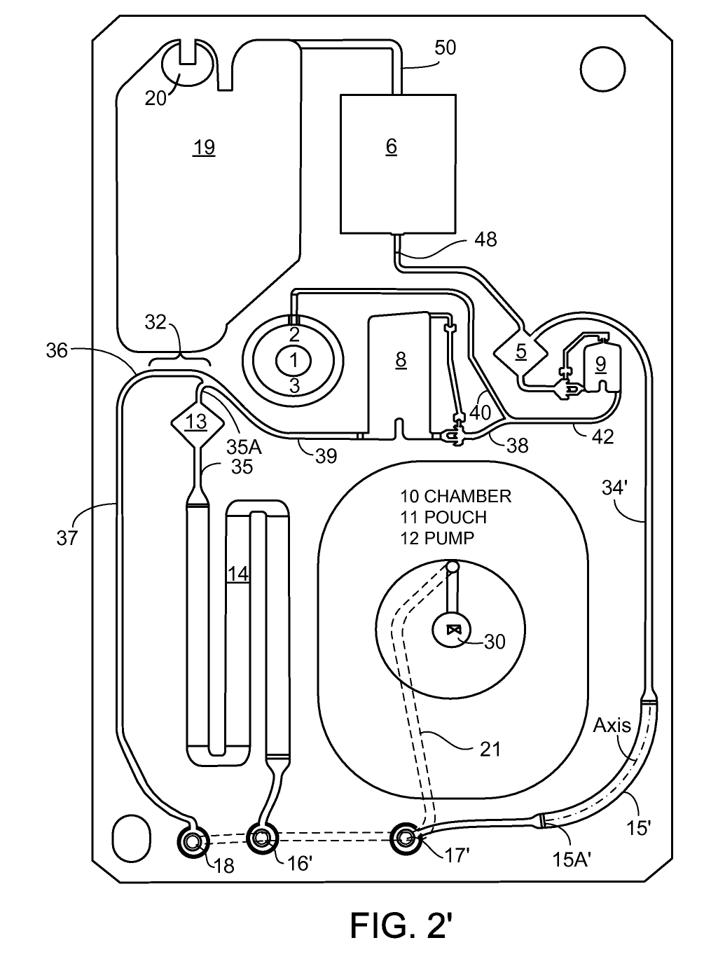

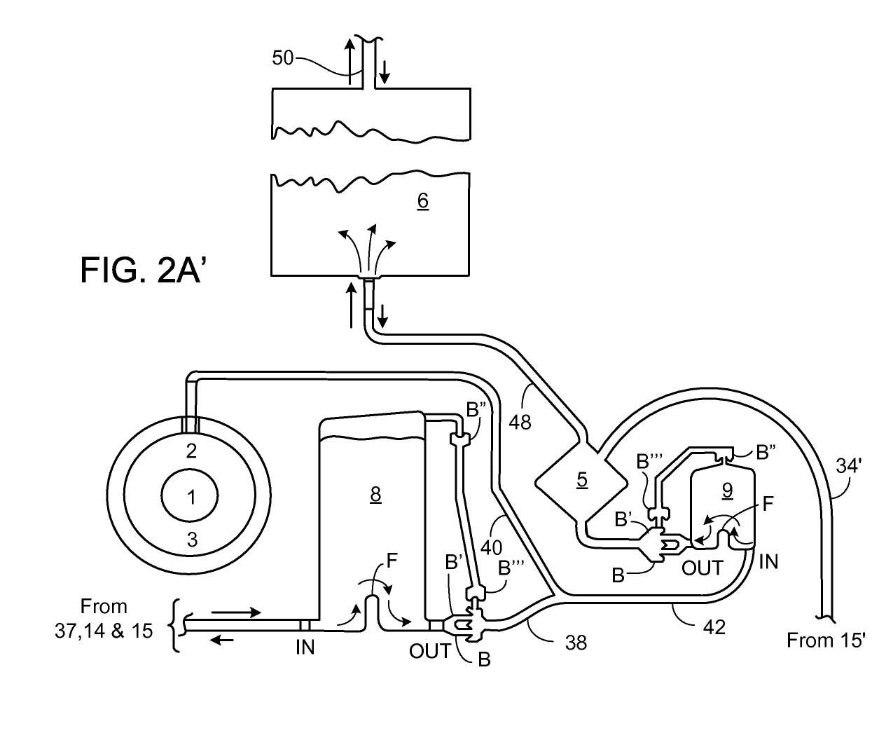

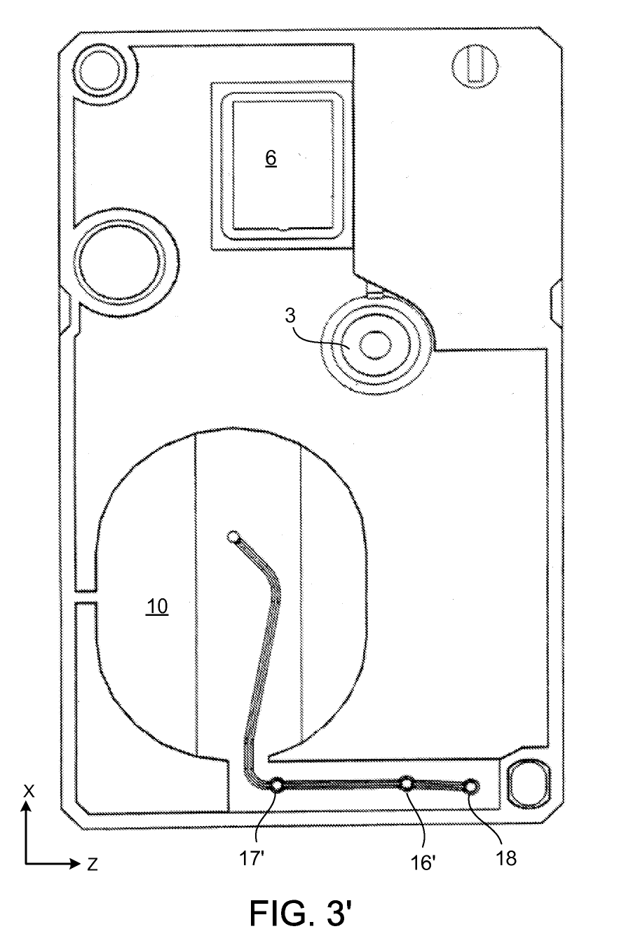

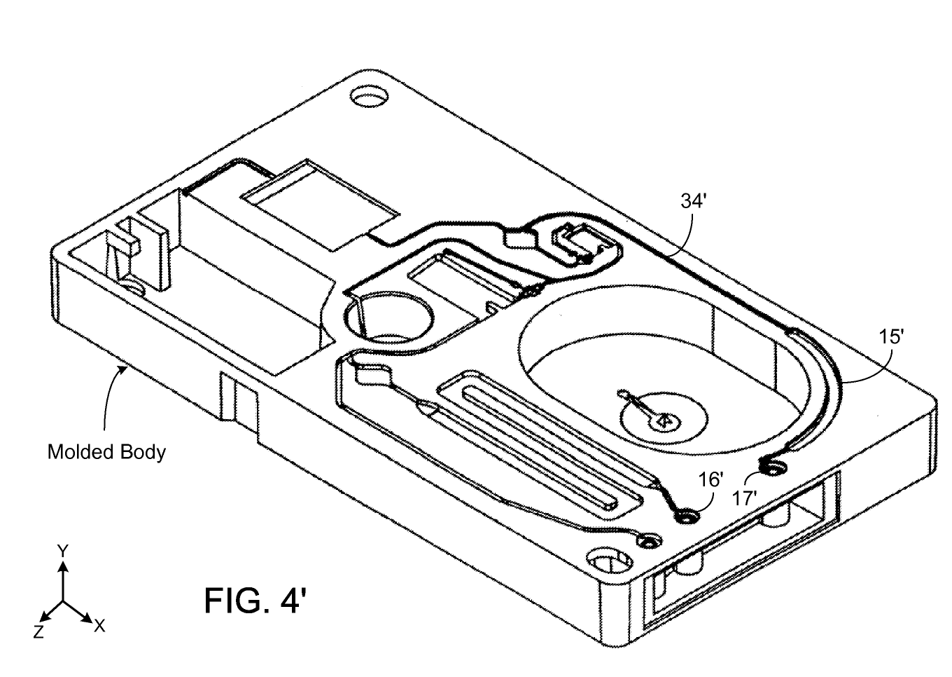

FIGS. 2′, 2A′, 3′, 4′ and 5′are views similar to FIGS. 2, 2A, 3, 4 and 5, respectively, of a cassette implementing features of the cassette form shown in FIG. 1′;

FIGS. 6 and 6′ are schematic 3-dimensional views of polyethylene frit segments;

FIG. 6A is an exploded view and 6B an assembled diagrammatic view of a segment of foam or frit in a reagent chamber;

FIG. 6C is a photomicrograph of a cellulose foam which is indicative of the structure of micro-porous nitrocellulose;

FIG. 6D is a photomicrograph of melamine foam;

FIG. 7 is an exploded 3-dimensional view of a buffer liquid pouch;

FIG. 7A is a view of the completed pouch, containing stored buffer liquid, in operating position prior to being compressed by the piston;

FIG. 7B is a similar view of the pouch partially compressed by the piston sufficiently to be pierced;

FIGS. 7C is a similar view showing positive displacement of fluid;

FIGS. 7D and 7E are similar views of the pouch illustrating alternate operation as positive displacement pump and suction (negative displacement) pump;

FIGS. 8-8H illustrates steps in the flow protocol employing the cassette of FIGS. 2-5 while FIG. 8I shows the purge and prime sequence of the protocol in tabular form;

FIGS. 8′-8H′ illustrate steps in the flow protocol employing the cassette of FIGS. 2′-5′ while FIG. 8I′ shows the purge and prime sequence for this cassette;

FIGS. 9-9C illustrate steps of a forward-backward-net advance flow protocol in respect of the reaction chamber;

FIGS. 10 and 10A are timing diagrams showing cyclic flows, and by amplitudes indicated, the net advance of fluid to dump to the waster chamber in cassettes according to FIGS. 2-5;

FIG. 10A′ is a description in tabular form of a pumping protocol defining the various flows for preparation of the cassette of FIGS. 2′-5′ and in running an assay employing it.

FIG. 11 provides experimental results showing the effect of the feature of FIG. 6;

FIG. 12 is an isometric view of a system control unit which incorporates a reading capability; FIG. 12A is a plan view of the interface of the unit with the face side of the cassette of FIG. 2; FIG. 12B is a diagrammatic cut-away view of the control unit showing mechanical actuators for the cassette; FIG. 12C is a similar cut-away view of the reader system within the control unit.

Like reference symbols in the various drawings indicate like elements.

### DETAILED DESCRIPTION

Diffusion is the dominant process that brings molecules such as proteins into proximity/binding in a low Reynolds Number fluid flow. The technology presented here offers a number of techniques that together speed the process of molecular coupling and reduce manufacturing cost. These include (i) a hydrophilic support upon which proteins are desiccated that offers a very large surface to volume ratio and (ii) a technique employing the support that fluidizes (liquefies) desiccated molecules to achieve approximately homogeneous properties within a specific fluid volume and transport of the fluid homogeneously with little alteration over the capture surface; (iii) a pouch for reagent storage that serves as the pump body and permits limited bi-directional fluid transport; (iv) separate, cascaded bubble traps for sample and reagent that enable sample volume to be small and allow for a robust design that compensates for variations of pumped reagent volume; (v) techniques that improve mixing in supply channels and a flow-through reaction chamber for achieving spot-to-spot consistency, which include forward and backward flows with periodic net forward advance in flow through assays; and (vi) mixing channels employing chaotic mixing techniques.

The novel features cooperate in a novel way to achieve a cassette having a flow assay reaction chamber (6) constructed for back and forth liquid mixing in a narrow gap (G) over an array of capture agent (S), with net flow advance to waste confinement (19) produced by a reversible pump (3 or 12), preferably operable with rolling diaphragm action with at least limited elastic recovery, that advances sample or buffer liquids through conditioning paths (4A, 8, 8′, 9, 14, 15, 15′) before reaching the reaction chamber (6), the pump producing accurate flow control, liquid conditioning, e.g. liquefying dry reagent from internal surfaces of flow-dividing material (14a, 15A, 15A′, e.g. open cell foam or frit), heating (4A), and air bubble removal (8, 8′, 9), as well as replenishment of reagent while accomplishing mixing within the flow-through reaction chamber (6); in the case of the pumping of buffer liquid, preferably lower viscosity buffer liquid is arranged to propel higher viscosity reagent liquid, the flow-dividing storage material preserving the concentration of the reagent; a blister pack (11) on the cassette containing buffer liquid acts as the reversible pump (12) in producing accurate forward and backward flows with the net flow advance; and cascaded bubble traps (8, 9) on the cassette render the system tolerant of minor pumping error during cassette priming.

### Storage of Dried Reagent

Proteins in solution (as well as other assay reagents) including sample conditioning agents are commonly dried for storage by simple evaporation, spray dry or freeze-dry processes onto a hydrophilic surface to preserve their biological properties. The proteins (or other reagents) may be reconstituted by later fluidization to restore their activity. The hydration process is accelerated when the material is presented as a thin layer to the hydrating fluid.

As most injection-moldable plastics for cassettes such as polycarbonate or COC are hydrophobic, it is customary to coat a protein storage chamber of a cassette with a layer of “sacrificial” protein to make the wall hydrophilic.

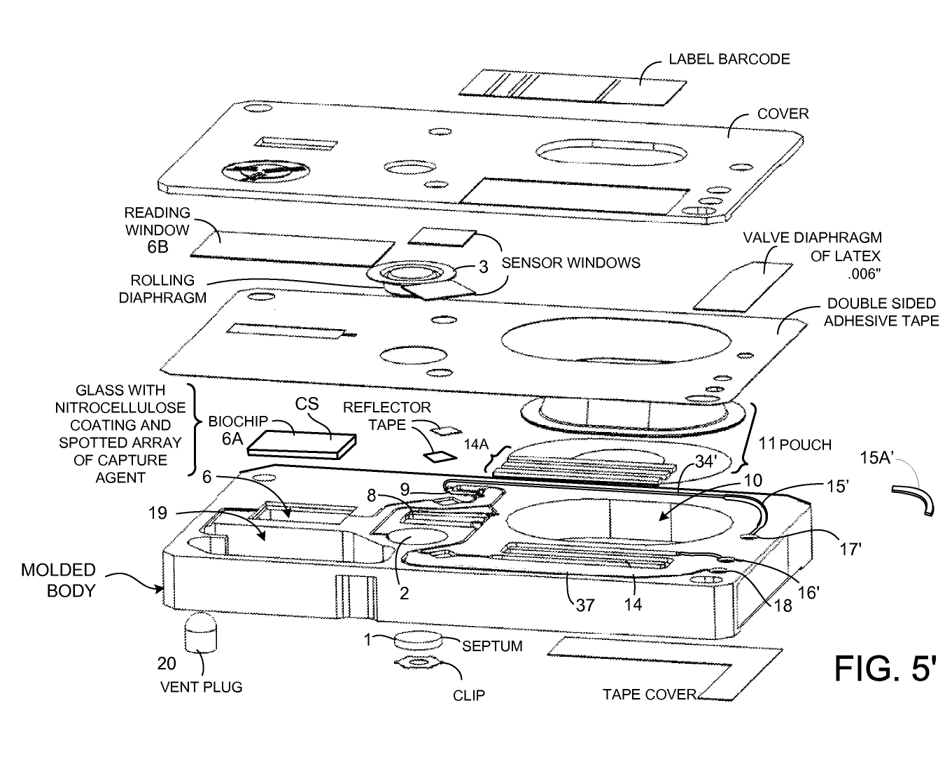

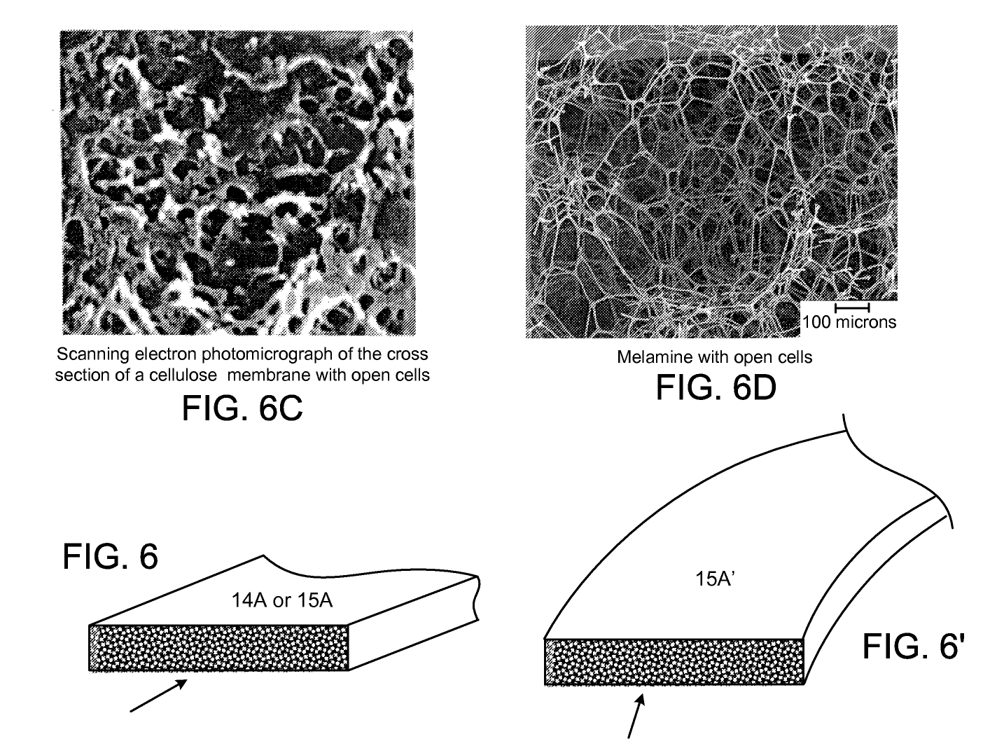

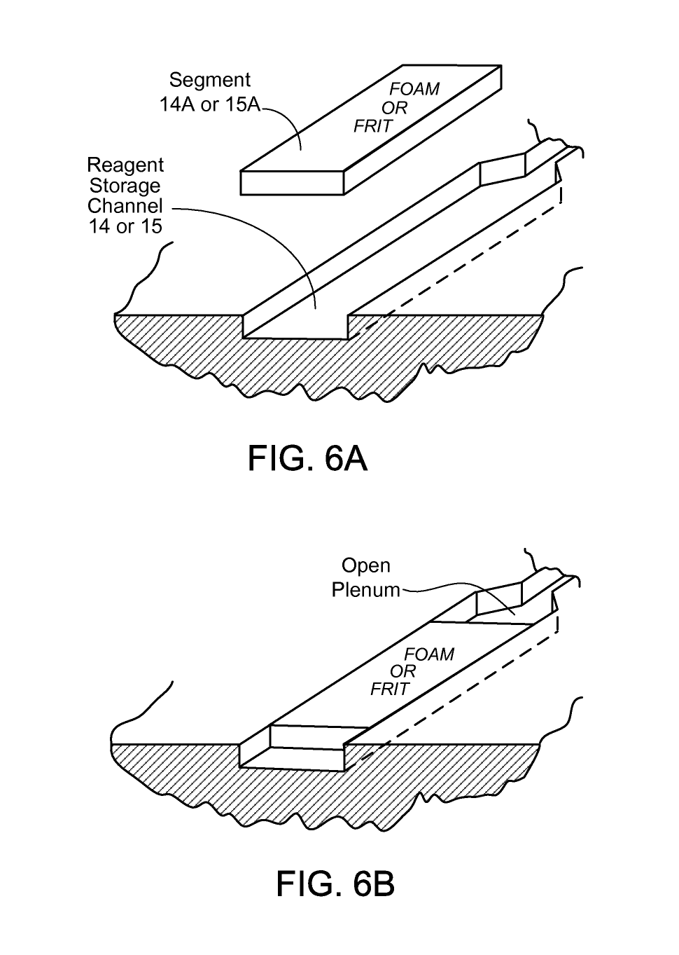

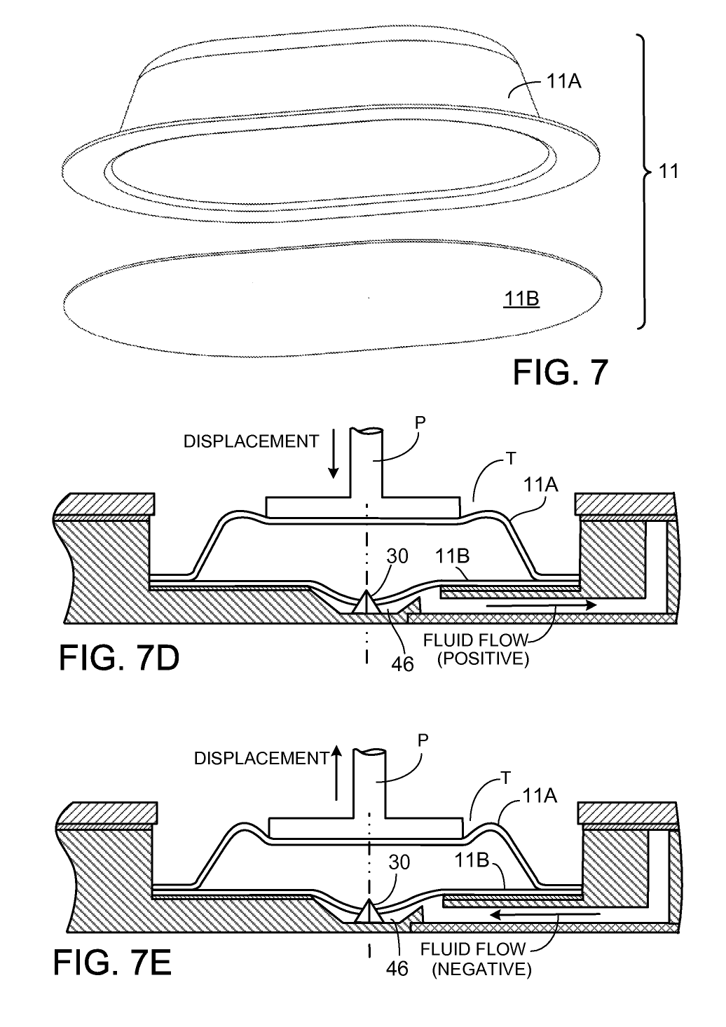

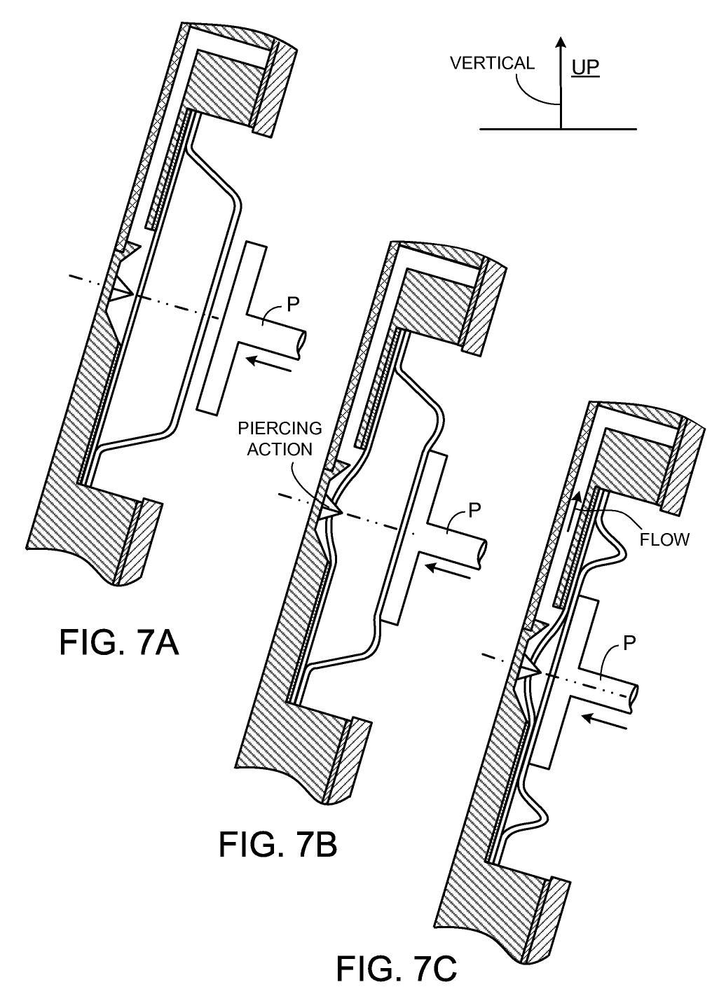

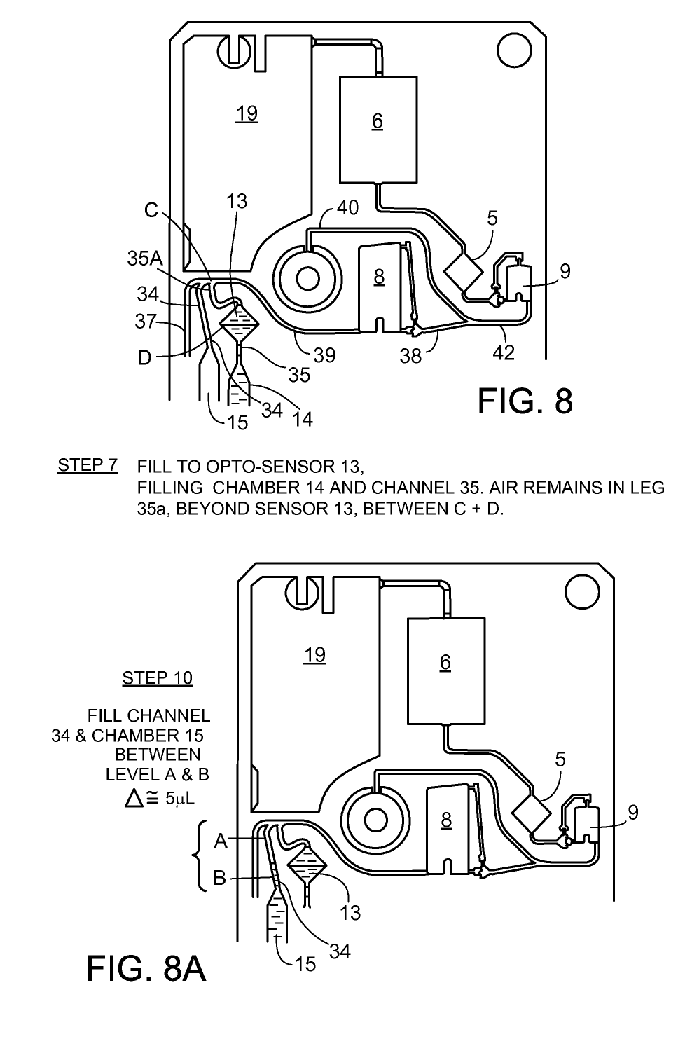

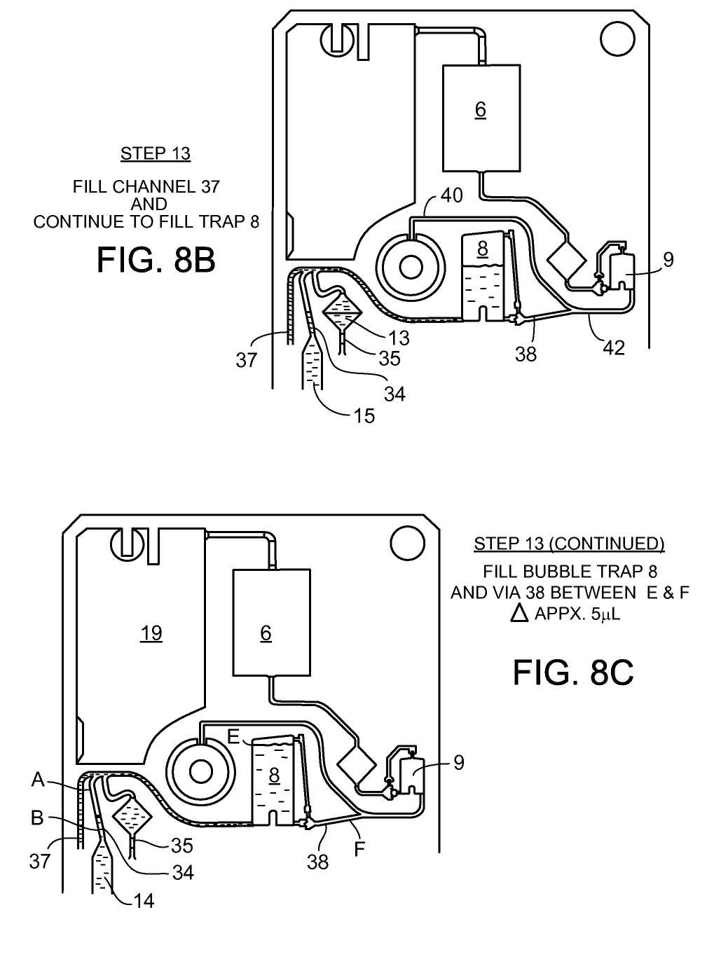

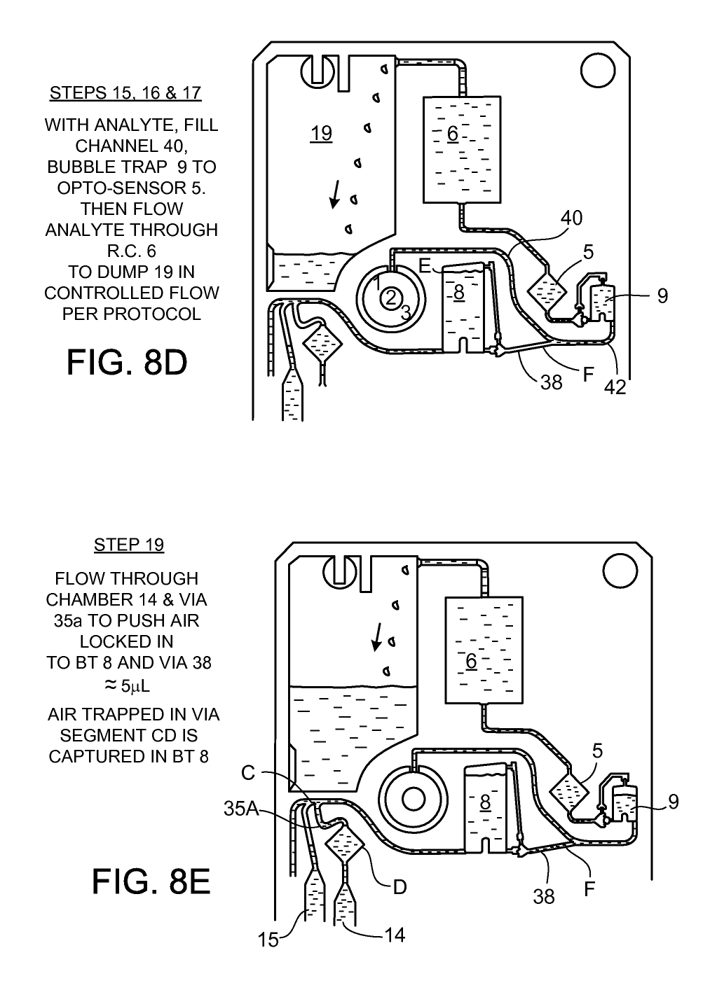

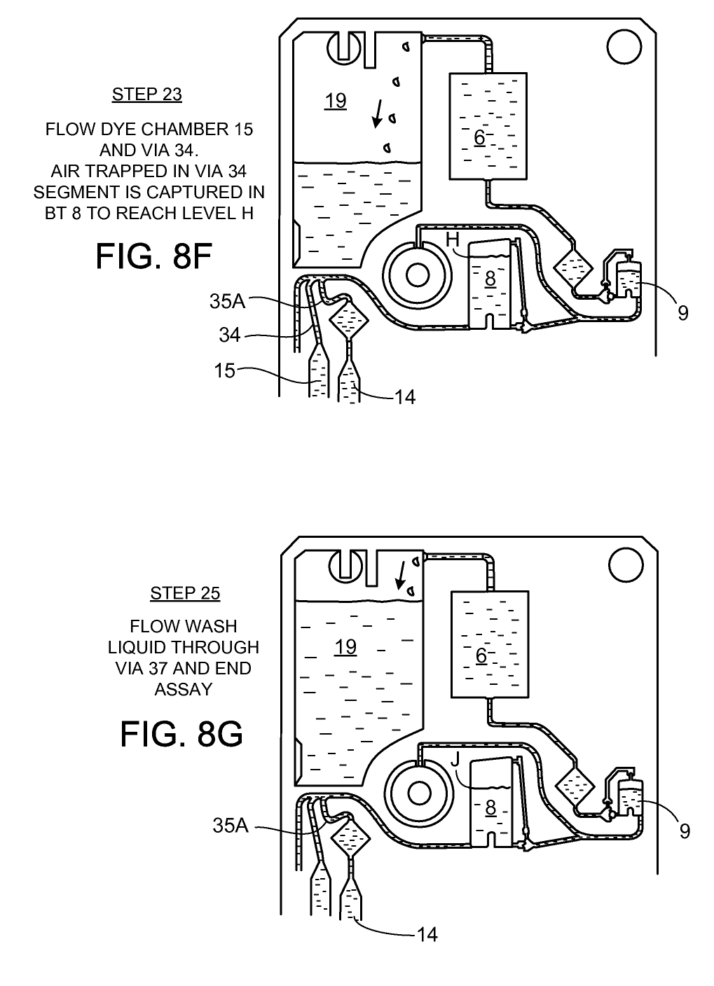

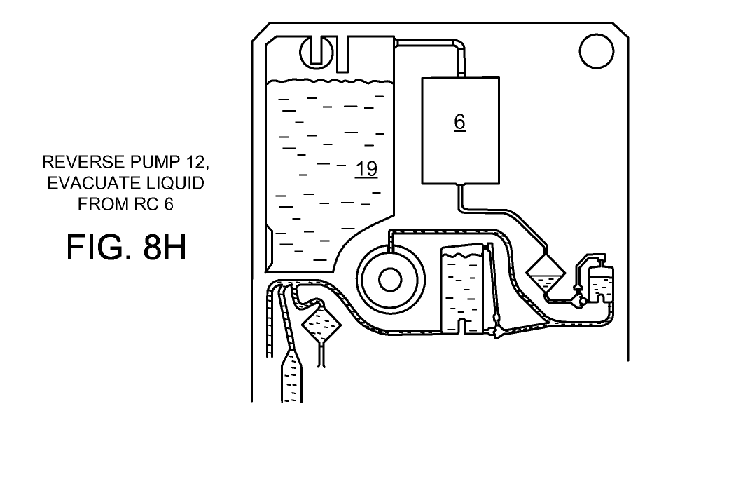

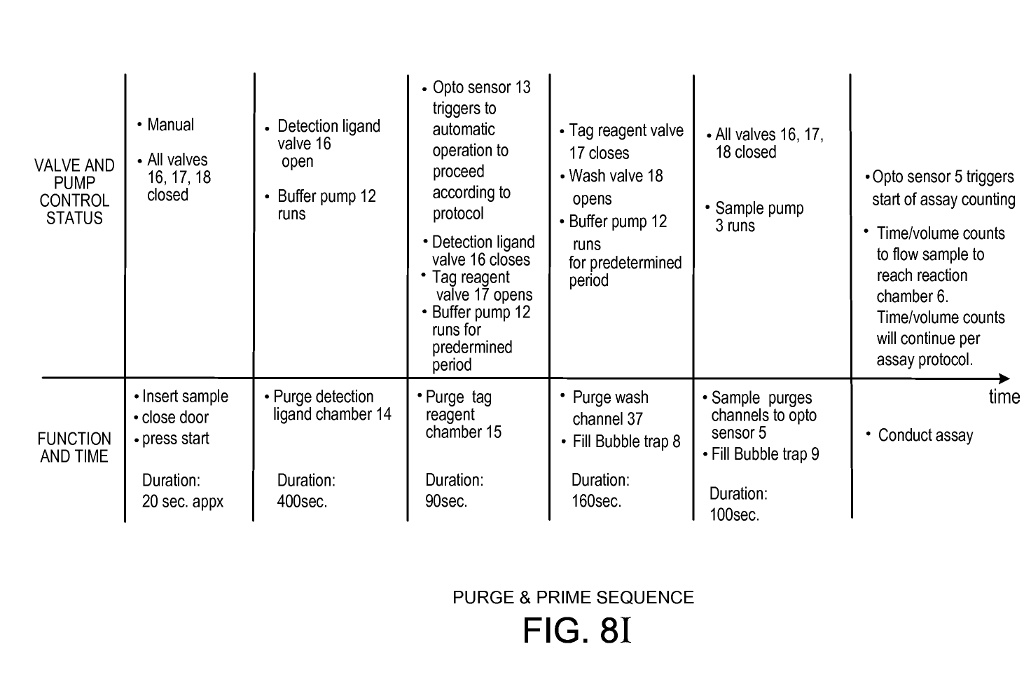

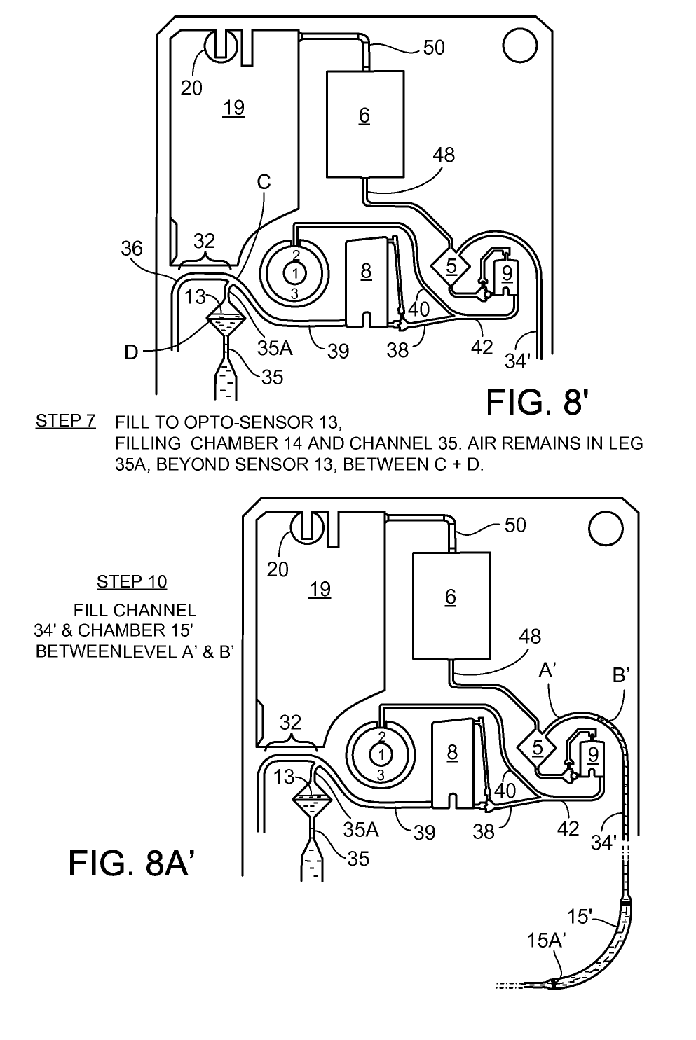

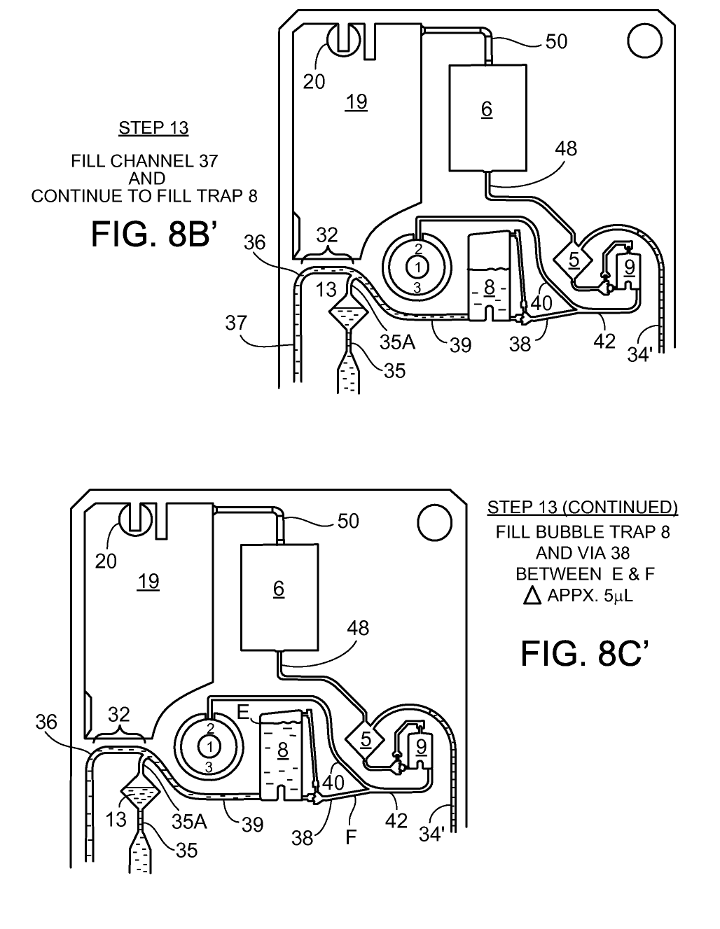

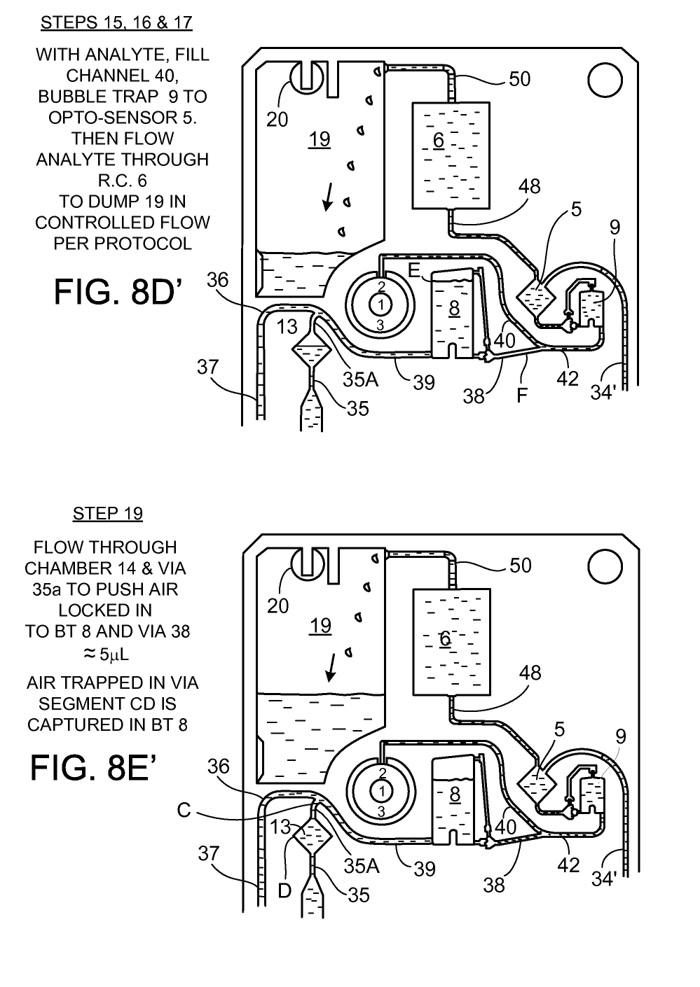

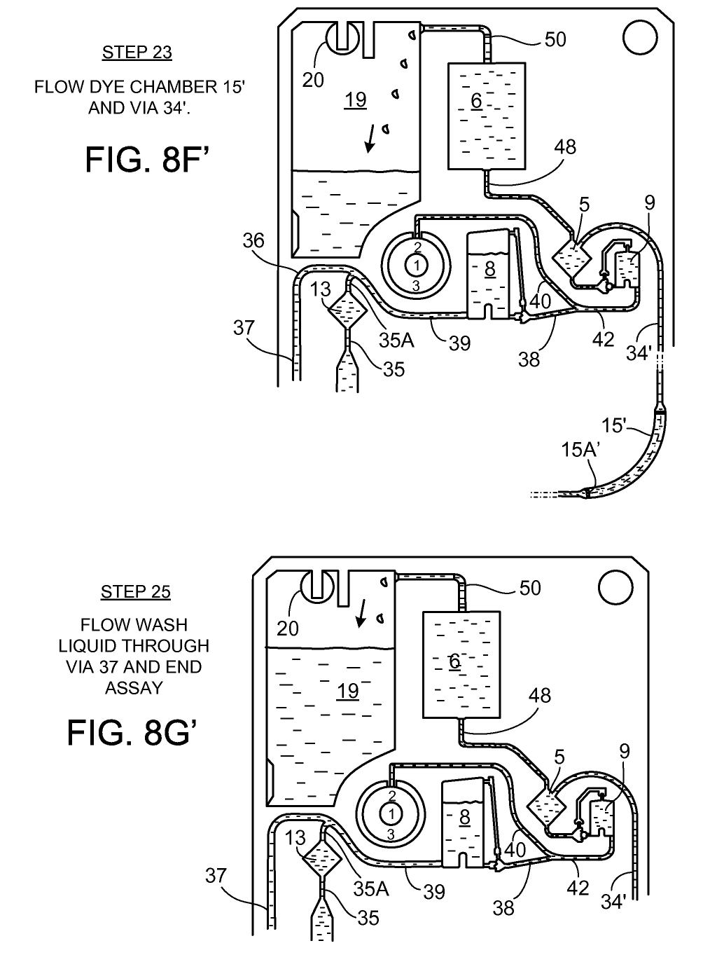

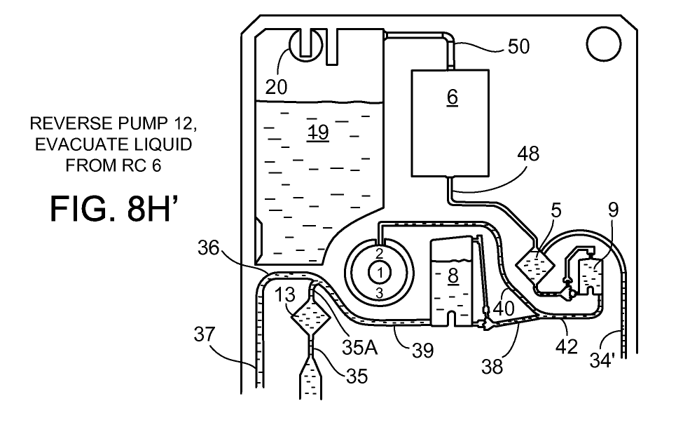

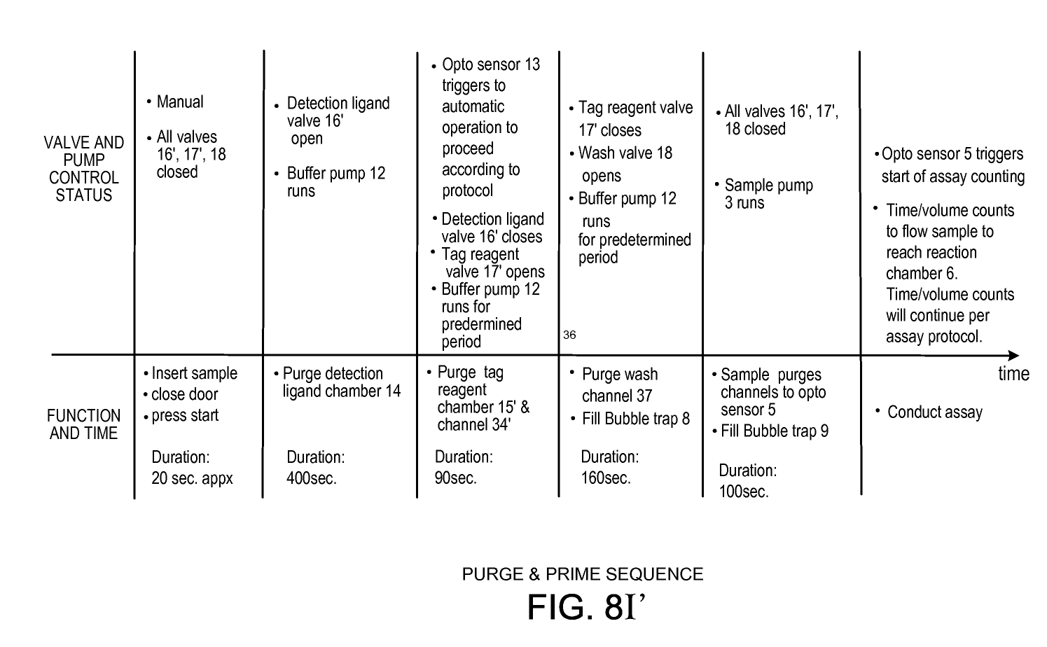

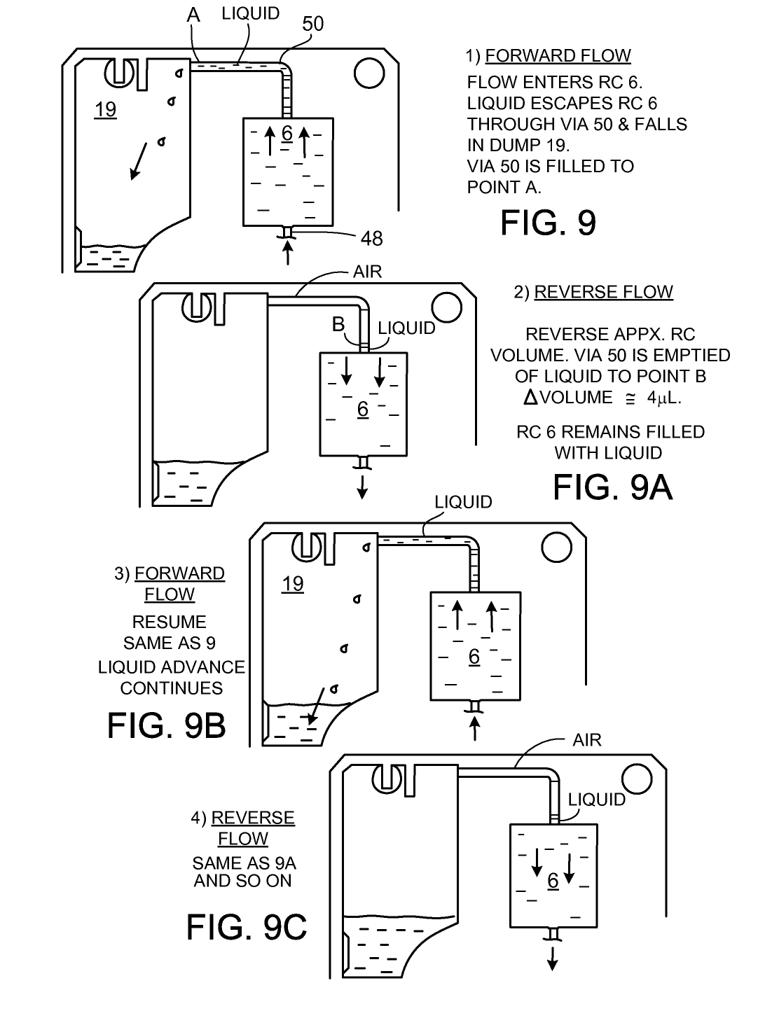

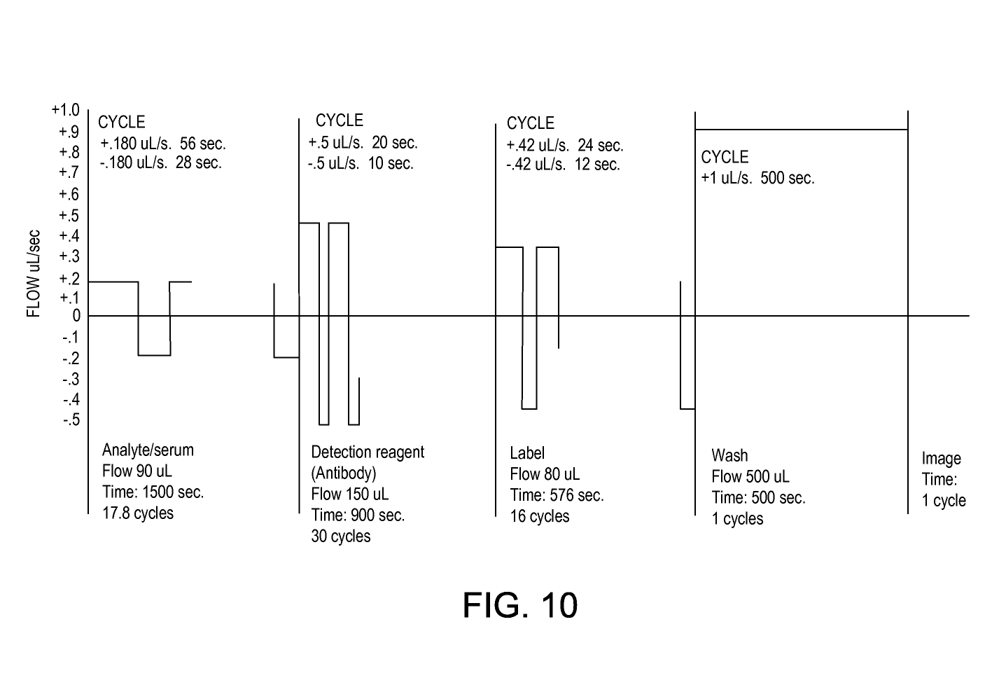

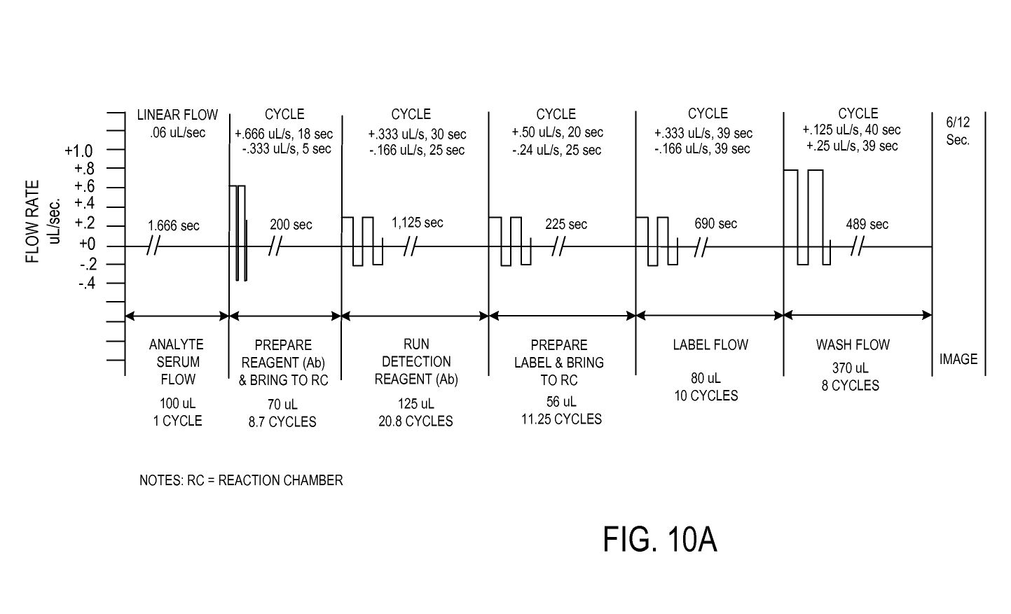

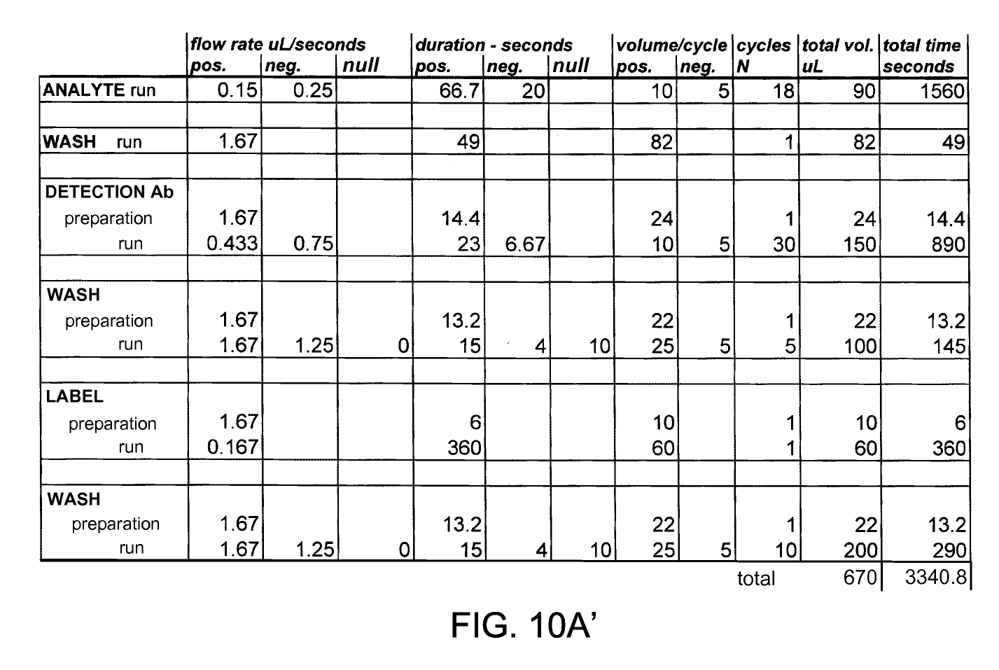

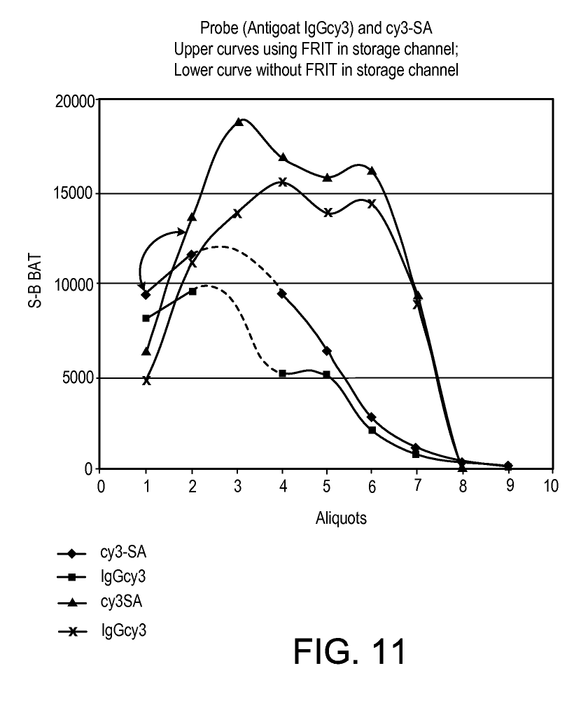

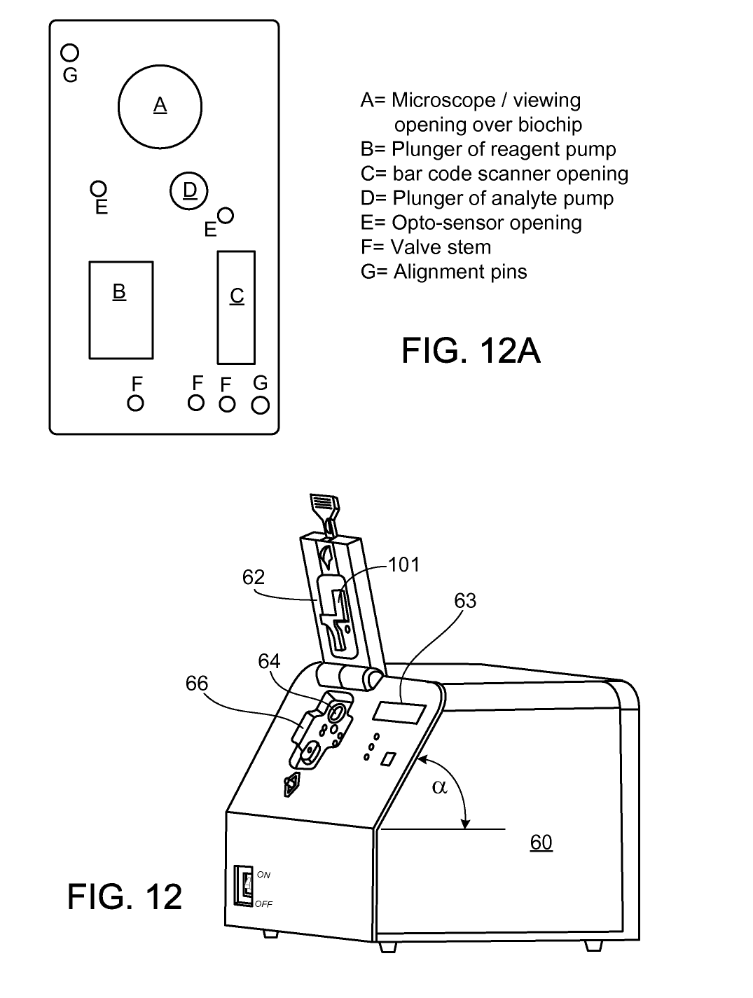

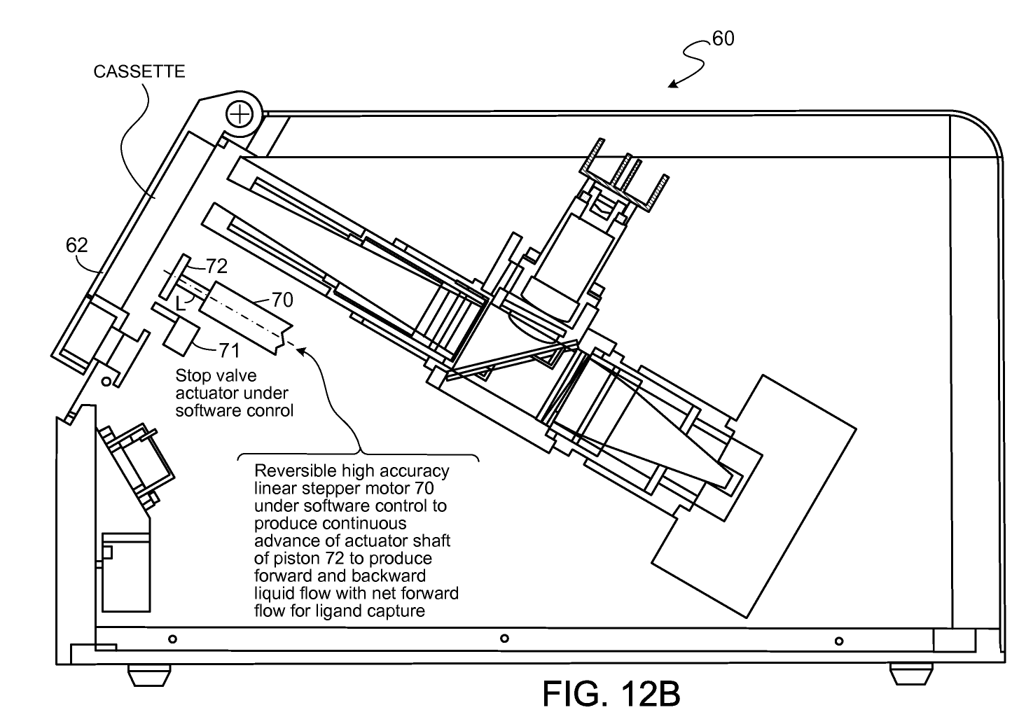

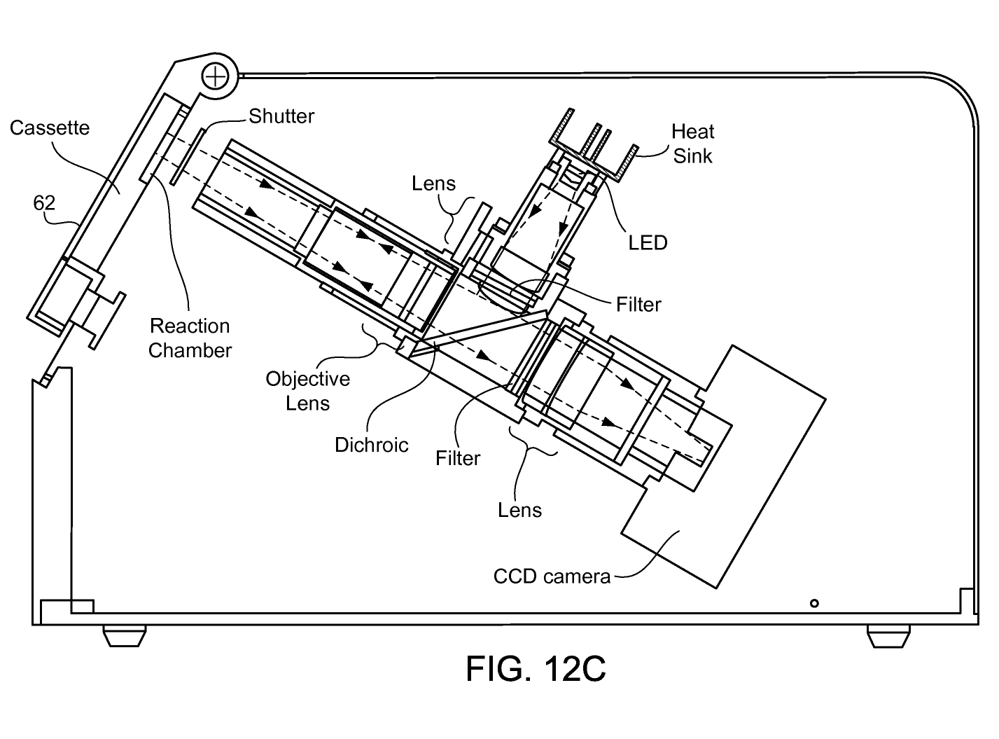

In the present case proteins in solution are preferably imbibed into a porous member 14A and 15A, FIGS. 5 and 6-6D, 15A′, FIGS. 5′ and 6′, preferably an open cell hydrophilic foam or frit. Examples are hydrophilic polyethylene, for example number 4897 or 4898 from Porex, melamine foam such as “Basotect” from BASF, and hydrophilic polyurethane. The material is selected to support protein but exhibit minimum capture properties so the proteins are in a releasable condition. A nitrocellulose membrane is an undesirable choice unless treated with a blocker material that reduces protein attachment such as BSA (animal sera) or that interferes with bonding (e.g. Tween, Triton, or Brij) or Polyethylene Glycol; similarly polystyrene is undesirable unless similarly treated.

The foam or frit is shaped to closely fit the channel 14, 15, or 15′ in which it is to be inserted and is loaded with liquid containing the correct amount of reagent e.g., mix of antibodies or a tag reagent. It is preferably air dried, with dried reagent distributed on the surface throughout, and stored for later installation in the appropriate channel. This technique permits economical, simple assembly of cassettes, for instance automated assembly. Advantageously, the storage channels 14, 15 are straight, of constant transverse cross-section, or at least of constant depth channel 15′, and the filling material is provided in sheet form of thickness corresponding to the depth of the storage channels, being accurately cut to length and width closely matching the dimensions of the channels.

The reagent molecules coating the porous material present a hydrophilic surface to re-hydrating buffer entering the chamber during the liquefication phase of the assay process that efficiently prevents air entrapment in the chamber.

A fine pore foam or frit, such as the 50 or 100 micron pore size Porex 4898 and 4897, multiplies the free surface available for protein coating by a factor of 10 or 20 compared to the available surface of the walls of the channel that hold the element. Foams with smaller pores or fibrous (open cell) foam such as melamine offer a greater surface to volume ratio as expressed in U.S. Pat. No. 6,617,014. Consequently the thickness of the molecular accumulation is proportionally decreased and fluidization similarly facilitated and accelerated.

When the foam or frit insert is hydrated, protein molecules fluidized within the volume diffuse within it, tending to reach a homogenous concentration. There may be sufficient time in the assay, following hydration for uniform conditions to be achieved, without delay of the overall assay, for instance during the period in which the analyte is caused to flow through the reaction chamber. Both fluidizing and reaching a homogeneous condition can however be accelerated and enhanced with flow agitation within the holding chamber. It is advantageous that the chamber has, at both ends of the foam or frit insert, a small open plenum (FIGS. 4, 4′, 6A and 6B), such as 1 or 2 micro-liter volume, to receive fluidized reagent, to promote homogenization. Then fluid forward and backward motion (agitation) is driven by the buffer pump mechanism. Novel techniques achieve this function. It can be active for both the detection reagent and tag reagent storage chambers to create homogeneous concentrations of the reagent. In this technique, it is advantageous to propel fluid in an unsymmetrical manner to enhance the mixing process. Forward volume flow rate is preferably twice that of the return flow rate, for instance.

As will be described further herein, a novel adaptation of forward and backward movement in the storage channels is characterized by substantial net fluid advance of the fluid during each cycle. In this way not only can mixing be achieved within the storage chamber and passages leading from it, but also mixing can occur within the reaction chamber combined with progressive replenishment that keeps high the concentration of reagent in the reaction chamber.

Mixing Channels for Chaotic Mixing at Low Reynolds Number Flows

In the case that the flow paths are interlaced and open to one another as occurs within open cell foam or frit, mixing is enhanced by flow through the material. Thus in an assay cassette having flows limited to Reynolds number less than 1, a mixing flow channel extends in a general direction and is connected to supply reagent to a reaction chamber, the channel filled for a substantial length with a three-dimensional mass of the open cell foam or frit, see FIGS. 6-6D and 6′, selected to cause fluid flowing in the channel to split into a large multiplicity of relatively small flows along differing interlaced flow paths, the paths having flow components transverse to the general direction of the channel along with flow components in the direction of the flow channel, the individual flow paths varying in direction relative to one another and being open to interchange with each other effective to produce a substantially chaotic mixing effect upon liquid flowing into and through the open cell foam or frit material, the output of the channel arranged to supply flow of the thus-mixed liquid to the reaction chamber. Desirably, for ensuring the expression of air when initially filled, the surface of the foam or frit is hydrophilic. In important cases, where the mixing channel is also employed as a storage channel (see previous description “Storage of Dried Reagent”), a desiccated biological agent is supported on the porous surface, exposed to be hydrated by flow of liquid through the foam or frit. In important cases, the channel is connected to receive flow of a buffer liquid of viscosity substantially less than the viscosity of reagent exiting the foam or frit material.

The size of pores of the open cell foam or frit material is preferably between about 5 to 200 micron, in one case the size of the pores being selected from the group of materials comprising material having a nominal pore size of 30 micron, with variation plus or minus 50%, and material having a nominal pore size of 100 micron, with variation plus or minus 20%.

A useful mixing flow channel has rectangular transverse cross-section and porous material of sheet-form foam or frit closely fits the transverse cross-section over substantially more than half of the length of the mixing channel, in some cases the channel is of substantially constant transverse cross-section, of length at least about 60 mm and channel width and depth of about 2 mm and 0.6 mm, respectively.

### Plug-Like Flow

The reagent (hydrated bio-molecules) within the foam or frit held in the storage chamber are propelled out toward the reaction chamber by a flow of the relatively low viscosity buffer liquid. The foam or frit is found to behave in a manner similar to a fagot of micro capillary tubes and cause a “plug” transport flow profile where the fluidized proteins do not exhibit the parabolic flow pattern with zero molecular flow at the wall that would occur if the reagent storage chamber were not occupied by the foam or frit. The plug-like property of flow through capillary tubes was analyzed by G. I. Taylor (Dispersion of Solute Matter in Solvent Flowing Slowly through a tube; Proceeding of the Royal Society of London, Series A, Mathematical and Physical Sciences, Vol. 219, No. 1137. Aug. 25, 1953, pp 186-203).

We have realized that the porous material just described, e.g., open cell foam or frit segments 14A or 15A, FIGS. 5 and 6 to 6C, filling a reagent storage channel has a similar effect, producing plug-like flow through the channel, i.e., preventing the lower viscosity buffer liquid from forcing its way through the higher viscosity reagent (i.e., preventing a “Gulf Stream” effect).

We have verified this experimentally, for instance see the two higher curves in the graph of FIG. 11, in comparison to the lower two curves produced with an open channel. The construction and flow protocol described above permits the delivery of the fluidized volume within the storage chamber at a near-homogeneous protein concentration, with rapidly falling concentration tails, as shown in FIG. 11.

A cassette designed to perform a sandwich assay with these features is found to store and deliver the detection reagent (e.g., antibodies) in the above manner that closely approximates the “gold standard” syringe pump delivery of a pre-mixed antibody cocktail at constant concentration. We realize that in an alternate construction, a material comprising a substantially parallel set of small tubes, produced by molding or extrusion, can be used to provide storage surfaces for dried reagent, and similarly be used to produce a plug flow by direction of buffer liquid into the assembly, the discharge proceeding to a reaction chamber.

Back and Forth Mixing in a Flow-Through Reaction Chamber with Net Advance to Waste

Uniform molecular coupling at the capture surface in the reaction chamber is promoted by the back and forth liquid movement (FIGS. 9-9C), despite the process remaining, over-all, a flow-through process, with replenishment liquids progressing through the reaction chamber to the waste receptacle. Selected duration of the phases of the cyclic action determines the net fluid flow.

For this purpose, the reaction chamber 6 is constructed with a discharge passage or exit via 50 at its exit region sized to hold only the intended back-flow fraction e.g., approximately 4 micro-liter, with a safety margin; so that air never enters the reaction chamber but, such that excess fluid voids by gravity flow into the dump chamber 19, never to re-enter the reaction chamber. The exit via has a small section to prevent air from entering the reaction chamber as fluid is sucked in.

### Bi-Directional Flow Pouch

Another aspect of the disclosure is a bidirectional fluid flow pump-diaphragm/reagent-pouch-container (FIGS. 7-7E) useful for producing the back-and-forth flow. A pouch is constructed with a cup (formed with cold formable material such as “Blister Foil” CF501CSM from Hueck Foils or Formpack C400565 from Alcan) and lidded with compatible foil from All-Foil such as 100 series-0 aluminum 0.001 thick coated with CP3A Heat Seal3. The package is filled with reagent and free of air prior to complete closure.

The aluminum in blister foil is soft to permit forming. As the blister is formed, however, it work-hardens. This is found to impart a desirable level of elasticity to the blister cup that permits limited suction of the system by elastic recovery within a sufficient range of the permanently deforming pouch.

The buffer pouch 11 of the disclosure consists of a cup 11A and a lid 11B. In operation, the back of the cup is pressed upon by an external piston P and deforms in a manner somewhat similar to a rolling diaphragm of a conventional pump such as Model 1101 miniature compressor from Thomas of Sheboygan, Wis. 53081 (which may be employed as the analyte liquid pump 3). That is to say, the pouch is operable with a rolling diaphragm-type action with (limited) elastic recovery.

The external piston P driven by a stepper motor screw assembly deforms the back of the cup 11A of the pouch and forces the soft aluminum lid 11B upon a pin (awl) that pierces it and releases fluid to a duct system leading to various chambers. The lid is preferably flat and conforms to its mating flat anvil surface pressing out any remaining air. The mating flat surface holds in its central region a declivity out of which protrudes a sharp pyramidal shaped pin with a section missing to facilitate liquid flow. The soft aluminum lid ultimately deforms and impales itself, releasing its content in a manner controlled by the stepper motor signal.

The cup is shaped such as to offer minimum resistance to permanent deformation but also offers sufficient elasticity that, as the stepper motor is reversed and retracts the piston, fluid is sucked back, the combined actions enabling forward and backward fluid flow within selected ducts and chambers as controlled by associated valves.

### Bubble Trap Cascade

Incorporating separate bubble traps for the sample and the fluids that perform all other functions, and connecting them in cascade in manner that captures the trapped air, as previously mentioned (and see FIGS. 8-8H and 8′-H′), offers the advantage of minimizing the necessary sample size (the sample bubble trap is relatively very small). This offers a robust construction that is tolerant of fluid flow variations, e.g. within the predetermined error range of the relatively crude and low cost pumping system formed by the blister pack, the error range determinable by a set of trials. Air purging and sample processing can proceed such that small volumes of air not purged prior to sample processing may be captured in the sample bubble trap. The error tolerance provided by this arrangement enables use of the simple and relatively low cost pump arrangement while still achieving high accuracy of liquid flow.

### Flow Assay

The disclosure is specifically applicable to a continuous flow (or “flow-through”) assay as compared to a fixed volume assay, and especially to a protein flow assay. A progressively replenishing flow-through assay (FIGS. 9-9C, 10) is especially advantageous where the analyte carries a very low concentration of molecules of interest as it provides higher concentrations and improved diffusion in the reaction chamber and consequently a better detection process.

It is known in the industry that the coupling binding-level of a protein assay is proportional to the molecular density of both the capture reagent and the analyte. In a fixed volume assay, as the analyte molecules bind to the capture molecules, the analyte concentration in the fluid is reduced by depletion, therefore limiting the number of coupled molecules and ultimately the signal to noise ratio. A benefit of the through-flow assay is to remedy the depletion effect by progressively offering un-depleted analyte fluid, therefore increasing the apparent molecular density of the protein of interest and consequently the efficiency of the assay.

### Presently Preferred Implementations

The preferred implementations represent improvements over an effective system for conducting assays within a cassette described in our patent applications entitled “ASSAYS BASED ON LIQUID FLOW OVER ARRAYS”, publications US 2006/0275852 A1 and WO 2006/132666 A1, which are hereby incorporated in their entirety by reference with respect to construction and operation of like features in the present application, and the variations mentioned there.

Known Features of Flow-Through Cassettes

The flow-through cassette types illustrated in FIGS. 1, 1′ and 1″ employ known features disclosed in patent applications US 2006/0275852 A1 and WO2006/132666 A1 in addition to novel flow passage and bubble removal arrangements discussed later herein. The following features of FIGS. 1, 1′ and 1″ are known from those prior patent applications.

The flow-through cassette confines all liquids and reagents for the assay to the interior of the cassette.

Liquid sample containing an analyte, e.g. blood serum or plasma carrying antibodies of interest, is introduced through a septum 1 into a sample reservoir 2 within the cassette. A displacement pump 3 associated with the sample reservoir 2 forces sample liquid to flow. It flows through a path to condition the liquid as appropriate for the selected assay, then through a narrow flow gap reaction chamber 6 in a progressively replenished flow that exposes the conditioned sample liquid to capture reagent, and then to waste storage 19 for isolation. The capture reagent may be an array of capture agents, for example, a two dimensional array of spotted proteins on a planar capture surface.

Buffer liquid is stored in a pouch within the cassette. A pump 12 forces buffer liquid through paths in which the liquid is conditioned as appropriate to the assay, then through a narrow gap reaction chamber 6 in a progressively replenished flow to expose the conditioned liquids to capture regions, and then to waste storage. In one case the buffer liquid, to serve as wash liquid, is forced through a bubble removal system for conditioning the liquid before reaching the reaction chamber 6. In other cases, buffer liquid to serve as hydrating and carrier liquid is forced into chambers 14 and 15 to liquefy reagents within those chambers and through a bubble removal system for further conditioning of the liquid before reaching there action chamber 6. For an immunoassay, dry detection antibody reagent is provided in chamber 14 and dry fluorescent tag reagent (label or dye) is provided in chamber 15.

Conditioning of liquids before reaching the reaction chamber 6 is also produced by heat exchanger 4 which may heat the liquids of the assay in the areas outlined by dashed line 4A and 7. The heat exchanger at 4A may bring the liquids to approximately assaying temperature, e.g. physiological temperature, 37° C., and maintain that temperature in the reaction chamber at 7.

The bubble removal system in the form of a bubble trap operates on the buoyancy principle.

Flows in passages of the assay cassette are produced by externally driven pumps and externally driven stop valves. An optical sensor for controlling duration of pumping senses the arrival of a liquid-air interface in a respective passage. In other cases the duration of pumping is timed in accordance with an assay protocol implemented by a control unit. The control unit may include a pump and valve controller responsive to instructions (protocol) stored on machine readable medium, e.g., in the memory of a computer.

After flow through the reaction chamber 6, used liquid has been confined to prevent return to the reaction chamber. With reference to FIGS. 1, 1′, and 1″, for instance, the plane PL of our previously known cassettes has been oriented at a substantial angle to horizontal during use. Pumps produce upward movement of the liquids through the reaction chamber 6 while flow from the reaction chamber 6 to waste storage 19 occurs by gravity flow. The waste chamber is vented by hydrophobic vent 20. Upward liquid flows to waste storage prior to initiation of the assay expel air from the passages via the waste storage chamber and vent, while during the assay further air passes through vent 20 from the waste storage as waste liquid accumulates.

The functional relationships between the cassette and external apparatus as shown in FIGS. 1, 1′ and 1″ are similarly known.

FIGS. 12-12C show a system control unit 60 used in prior systems that incorporates all components for the external functions shown in FIGS. 1, 1′ and 1″.

Control unit 60 includes system display 63 and a receptacle 66 for the planar cassette which disposes the cassette at a substantial angle α to horizontal, here 60°. The cassette is latched into place by a door 62 that carries heater 101. Referring to FIG. 12B, two stepper motor linear actuators 70 (one shown in the diagram) respectively drive the plungers (pistons) of the pumps with great accuracy. Three linear movement valve actuators (valve stems) 71 (one shown in the diagram) respectively operate the active stop valves. The progress, performance, and results of the assay can be observed and monitored by system display 63 or by the monitor of an associated computer that also may store and read the protocol instructions, control the pump and valve actuators, and record the assay measurements. A microscope contained in the control unit 60 directs stimulating radiation through the transparent window of the cassette to the labeled complexes on the capture surface within the reaction chamber. Via the window, the microscope receives and measures fluorescence produced by excited labels of the complexes. After the reaction is complete and all measurements have been taken, the cassette can be removed from control unit 60 and discarded.

Implementation of Novel Features

The cassette forms of FIGS. 1 and 1′ are substantially the same except that in FIG. 1′ the label reagent passage by-passes the bubble removal system. An Implementation of these two cassettes form is shown respectively in FIGS. 2-5 and 2′-5′. Their features cooperate to enable more highly consistent quantitative assay results to be obtained with low abundance analytes, while simultaneously enabling significant reduction in cost of the cassette by efficient use of expensive detection reagent and a simple assembly that requires fewer parts .

In particular, these implementations illustrate back and forth mixing in flow-through reaction chamber 6, with net flow advance of the liquid to waste confinement, produced by remotely located pumps (3 and 12, FIGS. 2 and 2′), which advance the liquid through paths for conditioning before reaching the reaction chamber 6 and waste storage 19. A single pump system thus combines accurate liquid flow control, liquid conditioning such as liquefying, mixing, heating, and removal of air bubbles, and replenishment of reagent while accomplishing mixing within the flow-through reaction chamber 6. This flow maintains a high kinetic reaction rate, resulting in a short duration, highly consistent quantitative assay within a simple cassette at relatively low cost.

Referring to the exploded views FIGS. 5 and 5′, a molded cassette body defines the flow passages. Pre-formed devices for insertion into respective cavities of the molded body include: (1) precisely shaped flow-dividing segments of reagent-laden material 14A, 15A and 15A′ (FIGS. 6, 6′ and 6A); (2) a buffer liquid-containing blister-pack pouch 11 that serves as a pump body for buffer liquid pumping, (FIGS. 7-7D), and (3) a rolling elastic diaphragm pump member 3.

(1) Segments 14A, 15A and 15A′ of flow-dividing material closely fit channels 14, 15 and 15′ in the cassette body so that liquid is confined to pass through the material of the segment. For this purpose the channels are preferably molded of constant depth that matches the thickness of an available sheet-form foam or frit material as identified above, and the edge walls of the channels and the edge walls of the segments are square for ease of fabrication. The closely fit condition prevents by-pass flow of liquid around the flow-dividing material. It may be instance be achieved by a press-fit relationship, or a relationship in which clearance between the channel walls and walls of the material are sized to approximate the size of passages through the material e.g., the size pores in porous material.

The sheet is cut by a suitably shaped die to closely match the profile of the molded channels. Segments 14A and 15A and matching molded channels are straight, preferably of length in the direction of flow at least ten times the maximum transverse cross-sectional dimension of the segment. As seen in FIG. 5′, to efficiently utilize the footprint provided by a cassette, a more complicated shape of the insert is employed, for instance the curved “banana” shape in plan view (profile) of segment 15A′ of FIG. 5′, which efficiently fits a corner region of the cassette. Even with such special shapes, the flow-dividing material segment preferably has constant thickness as determined by the thickness of a sheet from which it is cut, and has square-cut perimeter edge surfaces, and the channels and segments have the substantial elongation in the direction of flow.

After cutting from the sheet the segments 14, 15, 15′ are loaded with liquid containing an accurately measured amount of reagent, e.g., a mix of antibodies or a tag (label) reagent, and dried to provide the thin layer distributed on the internal passage surfaces throughout the body of the segment. The segments are then stored for later installation in their respective channels.

(2) The pouch 11 of FIGS. 5, 5′, and FIGS. 7-7E, besides serving as a pre-filled container of buffer liquid for insertion into the cassette, in novel manner forms the body of a bi-directional liquid flow pump operable with a rolling diaphragm-type action with (though very limited) elastic recovery. This “pouch-pump” advances the liquid: (1) into the flow-dividing segments 14A, 15A and 15A′ for hydrating the reagent and mixing, (2) through the cassette passages and bubble trap 8 for priming the cassette, (3) through the narrow flow gap (G) reaction chamber 6 for progressively displacing the reagents and wash liquid for reactions and washing, and (4) thence to waste confinement, have storage chamber 19.

The pouch, filled with reagent and free of air prior to its closure, is pre-manufactured and stored, available for assembly of the cassette. In assembled position, the lid 11B of the pouch is set in opposition to a piercing pin or awl 30 at the bottom of the buffer cavity. For priming the cassette, the back of cup or blister 11A is pressed upon by external piston P. The pouch lid, of soft material, thus thrust against piercing awl by the pump actuator P, is pierced to release buffer liquid. The liquid flows into the confined space provided by collecting gutter 46 and delivery passage 21 in accordance with controlled deformation of the pouch by the linear actuator of the pump, FIGS. 7B and 7D. The flow rate and time of flow of liquid in the buffer passage directly depends upon the rate and duration of movement of the piston P, controlled by control unit 60. As the bottom of the cup 11A of pouch 11 is depressed, the side wall of its material, in the region continuous with the bottom of the cup, deforms, tending to roll and fold, progressively being shortened in height.

During the initial deflections of the priming sequence of the cassette, the bottom of the pouch is only slightly deflected inwardly by the actuator. In this range it is found to have such a dependable linear pumping response that it enables filling of the passages with acceptable flow rate accuracy. Deflection of about 0.012 inches corresponding to about 5% of the volume of the pouch is sufficient for the priming sequence. In the further phases of the assay, the accuracy of the pouch-pump is found to be sufficient to enable highly consistent results to be obtained from cassette to cassette.

For rearward pumping an elastic recovery property of the permanently deformed buffer pouch (though limited in range) is employed to provide the return forces as previously described.

The limited rearward motion of the back of the pouch is precisely controlled by controlled rearward movement of the linear actuator, against which the pouch elastically presses, in accordance with the pump protocol. This produces sufficient reverse flow of the buffer-based liquid to enable back-and-forth mixing in the reagent chambers, and in the flow gap reaction chamber 6 to promote uniformity of mixing, reaction and washing with the used liquid proceeding to waste storage 19 due to the net forward flow and eventual evacuation of the chamber for reading.

(3) The rolling elastic diaphragm pump member 3 of FIGS. 5 and 5′, obtainable as a purchased item, is sized to be inserted into a molded cavity of corresponding dimension. It is arranged to produce forward and reverse flows of the sample liquid in response to controlled movements of its linear actuator for likewise producing mixing action in the flow gap reaction chamber 6 as the sample liquid proceeds to waste storage 19. A suitable rolling diaphragm pump is Model 1101 miniature compressor from Thomas of Sheboygan, Wis. 53081

Note that pouch-pump 12 and pump 3 (and the valves 16, 17, 18) require only a pressure engagement by the ends of their respective actuators, which avoids need for any complicating devices or actions. Because of the residual resilience of the pouch-pump and of the true rolling diaphragm pump, the back of each pump maintains contact with its actuator even during rearward actuator movement. There is therefore no lost motion, and flows states are strictly based on the controlled forward, rearward, temporary dwell and stop motion states of the actuator.

Referring further to FIGS. 5 and 5′ and to FIG. 2G, as with prior known cassettes, biochip 6A is provided for insertion into a respective cavity, to define the capture surface (CS), as one side of the narrow flow gap (G) reaction chamber 6. The biochip may be a planar, rectangular segment of glass carrying an ultra-thin coating of solid nitrocellulose, on which is disposed capture agent, e.g., a two dimensional array of round spots S of capture agents with transversely extending rows of replicate spots (FIG. 2B). (In other implementations the capture agent may be presented in other manner). A reading window 6B, e.g. a planar segment of clear glass, placed in parallel at uniform spacing of about 100 micron from the capture surface, defines the narrow flow gap G over the capture surface that serves as flow-through reaction chamber 6. (In other implementations the flow gap dimension G may range from about 50 to 300 micron). A region of the flow gap located in the middle of the chamber, of dimension for instance 12 mm in the flow dimension and 4 or 8 mm transversely, is arranged to be imaged by the microscope of control unit 60.

Further, each of the assemblies, FIGS. 5 and 5′, as do previously known cassettes, has a cover adapted to receive a barcode label; a double-sided adhesive sheet; a segment of latex sheet, portions of which serve as valve diaphragms for stop valves 16, 17 and 18; reflector tape mirrors 11A and 11B for the bottom surfaces of optical sensing stations 5 and 13 that detect arrival of liquid-air interfaces in the passages; septum member 1 and its retainer clip for receiving liquid sample; vent plug 20 for the waste system and a tape cover for the back of the cassette body.

As seen most clearly in FIGS. 2, 2A and 2′, 2A′, in a novel cascade arrangement, separate bubble traps 9, 8 are provided for the sample and buffer-based fluids, respectively. The bubble traps are connected in novel cascade fashion. Exiting flow from trap 8 for the buffer-based liquid proceeds into trap 9. This enables removal of air trapped beyond trap 8 during initial filling of the cassette, as previously described. This provides a robust construction that is tolerant of fluid flow variations which enables use of the low cost blister pack pump arrangement and its degree of displacement error.

Whereas, in respect of the form of cassette of FIG. 1 and the implementation of FIGS. 2 and 2A all buffer-based liquids pass through the bubble removal system, in the cassette form of FIG. 1′ and the implementation of FIG. 2′ and 2A′, the label reagent by-passes the bubble removal system altogether, and thus avoids any possibility of reaction in the bubble traps with any residual molecules of detection agent, as described later herein.

In the cassette form of FIG. 1″, otherwise similar to FIG. 1′, a third bubble removal system is provided to remove bubbles from the label reagent.

Structure and Operation of the Implementation of FIGS. 1-5

1. The septum 1 is provided as the entrance through which the analyte-containing liquid is introduced to the cassette.

2. The analyte thus enters holding chamber 2 (sample reservoir).

3. The analyte pump 3 at the holding chamber is a rolling diaphragm displacement pump, arranged to be depressed by an external linear actuator or piston of the processing station, driven by a rotary stepper motor, and capable of both forward and backward flow pumping.

4. The analyte heat exchanger 4, heats Temperature Controlled Areas 4A and 7. Area 4A includes the analyte and detection and tag reagent liquids.

5. The analyte optical sensor 5 detects the presence of analyte as it is advanced by pump 3 toward the reaction chamber

6. In the reaction chamber 6 or “RC”, the analyte molecules are captured from the low Reynolds number flow by the array of pre-deposited spots of capture agent on the nitrocellulose slide, or “biochip” capture surface. Following analyte capture, the chamber is washed, then the detection reagent is captured from a further low Reynolds number flow. Then the label reagent is captured from a further low Reynolds number flow. And then, after wash, the chamber is evacuated for reading of stimulated fluorescence through the window.

The bio-chip is nitrocellulose-coated glass carrying a deposited two-dimensional array of spots of capture reagents, for instance 4 to 6 replicate spots of each given capture reagent, each set of replicate spots arranged in a separate row transversely to the direction of flow through the reaction chamber. The biochip is separated by a 100 micron flow gap from a light-transmissive cover or window (non fluorescent flat section of glass slide cover), to form the reaction chamber with low-profile, of approximately 4 mm width and 12 mm length, with flow depth of 100 micron. Inlet and outlet passages 48 and 50 are located at opposite ends of the reaction chamber 6.

7. The heat exchanger section 7 heats and holds all fluids in the reaction chamber at 37° C.

8. The upstream bubble trap (BT) 8 removes bubbles out-gassed from buffer-based reagent fluids heated to 37° C. and slugs of air captured in the passages preceding it.

9. The downstream bubble trap (BT) 9 removes bubbles out-gassed from the analyte liquid heated to 37 C as well as an air slug captured in the adjacent upstream reagent channel.

10. The buffer cavity or chamber 10 holds buffer liquid that is employed to liquefy both the detection reagent and the tag reagent, as well as provide filling of bubble-trap 8 and wash liquid.

11. The buffer pouch 11 inserted into cavity 10 stores and protects from leaks and losses the buffer liquid that is to be used to form the detection and tag reagent and wash liquids. It is comprised of cup 11A and lid 11B.

12. The buffer pump 12 is formed by the buffer pouch 11 and an external piston acting on it (FIGS. 7-7E). Back and forward motions of the piston P are controlled by an external linear actuator, driven by a rotary stepper motor (FIG. 12B). Advance of the piston pierces the buffer pouch and propels the buffer liquid and, thereby, the reagents (for which reason it is sometimes therefore referred to as the “reagent pump”).

13. The detection reagent optical sensor 13 informs the external processor that the detection reagent has filled the related channel and expelled air from that part of the cassette.

14. The detection reagent chamber 14 holds desiccated detection reagent, which is often (but not necessarily) an antibody; because of frequent use with antibody the chamber is sometimes referred to as the “antibody” or “Abd” chamber.

15. The tag reagent chamber 15 holds desiccated dye reagent, otherwise known as “label” or “tag” reagent.

16. The detection reagent chamber valve 16 opens or blocks liquid flow from the buffer cavity 10; valve 16 is typically located in the supply line between buffer liquid storage and the detection reagent chamber as shown in FIG. 2, not in the location shown diagrammatically in FIG. 1.

17. The tag reagent chamber valve 17 opens or blocks buffer liquid from entering the tag reagent chamber 15. The valve is likewise located as shown in FIG. 2.

18. The wash channel valve 18 opens or blocks the buffer liquid from entering the reaction chamber 6.

19. The dump cavity 19 or “waste chamber”, by gravity flow, accumulates and stores all discarded fluids that have flowed over the capture surface and exited the reaction chamber 6.

20. The vent 20 located in the waste cavity, allows passage of air out of the chamber, but blocks liquid escape.

Other structural features are as follows:

21. Buffer flow passage from buffer storage to valve network.

22. Buffer flow passage from valve 16 to detection reagent storage passage 14.

23. Buffer flow passage from valve 17 to tag reagent storage passage 15.

30. Piercing awl (pyramid form)

32. Manifold section 32, which joins reagent channels 34 and 35 and wash channel 37.

34. Dye (tag or label) reagent discharge channel 34.

35. Detection reagent discharge channel 35.

36. Washing channel discharge section 36.

37. Washing channel 37.

38. Discharge channel 38 from upstream bubble trap 8.

39. Inlet channel 39 to upstream bubble trap for merged flows of detection and label reagents and washing buffer liquid.

40. Analyte pump discharge channel 40.

42. Inlet channel 42 to downstream bubble trap 9, for merger of channels 38 from upstream bubble trap and 40 from analyte pump.

46. Gutter surrounding awl.

47. Outlet via from bubble trap 9 to optical sensor 5.

48. Inlet passage or via to reaction chamber.

50. Exit passage or via from reaction chamber.

Referring to FIGS. 2 and 2A, each of the bubble traps 8 and 9 is similar to the bubble trap shown in our previous patent applications, cited above, incorporated herein by reference. A difference is the form of divider F at the bottom (referring to the location in operating position, angle alpha, FIG. 12). Divider F serves to prevent blockage by large air bubbles. In the bubble traps of FIGS. 2 and 2A, each flow enters at inlet In, and leaves at outlet Out, at opposite sides of the bottom of the respective bubble trap. The raised flow divider formation F protrudes upwardly from the bottom, diverting the flow, as it moves across the width of the trap, to move upwardly, from which it proceeds downwardly to the outlet. Slugs of previously trapped air as well as air bubbles that reach trap 8 or 9, upon entering, move upwardly under buoyancy effects, to upper portions of the trap and do not reach or block the outlet.

The filling of each of the traps is accomplished by the technique described in our previous patent application. As liquid enters at In, the liquid begins to fill the lower region of the trap. Liquid is prevented from leaving through the outlet by the pair of capillary burst valves B and B′ which are constructed to conditionally block liquid flow, and burst only when a predetermined back pressure has been reached. Liquid fills the trap, the displaced air being forced to escape through a vent passage via capillary burst valves B″ and B′″, and thence through the passage network, through the reaction chamber 6 to the air vent 20 of the cassette. When the respective bubble trap is filled with liquid, the capillary burst valve B″ resists liquid flow out of the top of the trap, raising the pressure until causing a burst effect in the valves B and B′ at the bottom of the trap, permitting liquid to flow out the outlet. Upward liquid flow through the vent passage is prevented by burst valve B′″.

In order to process the assay reliably, the cassette and operating protocol are arranged such that no air may pass through the reaction chamber 6 once the analyte has started to flow. In this way, the risk of accumulation of disruptive gas bubbles in the reaction chamber 6, that can cause havoc with the results, is avoided. It is recognized that dimensional tolerances of parts as well as timing considerations may cause under-fill of some chambers and vias (channels). The novel fluid flow protocol and cassette design assure liquid flow free of all air through the reaction chamber 6 despite such inaccuracies of operation.

The functional sequences of actions that take place to perform an assay are as follows, referring also to FIGS. 2 and 8-8H, and the protocol of FIG. 8I:
1. Insert analyte liquid in chamber 2 via septum 1
2. Close valves 18 & 17 (wash passage and tag reagent chamber 15)
3. Open valve 16 (detection reagent chamber 14)
4. Operate buffer pump 12 (rotating stepper motor, depressing piston of buffer pump 12) to
5. Impale pouch 11 on awl 30 to release buffer liquid
6. Continue to operate buffer pump (depressing piston and compressing pouch 11) to fill detection reagent chamber 14, until
7. Opto-sensor 13 triggers
8. Close valve 16
9. Open valve 17
10. Operate buffer pump 12 a predetermined number of stepper motor steps to fill tag reagent chamber 15 and slightly beyond within error tolerance. Stop.
11. Close valve 17
12. Open valve 18
13. Operate buffer pump 12 a predetermined number of stepper motor steps to fill wash passage 37 and bubble trap 8 and slightly beyond within error tolerance. Stop
14. Close valve 18
15. Operate analyte pump 3 to fill bubble trap 9 until Opto-sensor 5 triggers
16. Continue to operate analyte pump 3 to flow analyte liquid through reaction chamber 6 per protocol.
17. Open valve 18 and operate buffer pump 12 to wash reaction chamber 6 with buffer liquid per protocol
18. Close valve 18
19. Open valve 16 and operate buffer pump 12 to flow detection reagent through reaction chamber 6 per protocol
20. Close valve 16
21. Open valve 18 and operate buffer pump 12 to wash reaction chamber 6 with buffer liquid per protocol
22. Close valve 18
23. Open valve 17 and operate buffer pump 12 to flow tag reagent through reaction chamber 6 per protocol
24. Close valve 17
25. Open valve 18 and operate buffer pump 12 to wash reaction chamber 6 per protocol
26. Prepare chip for imaging.
27. Image the biochip through the window of the reaction chamber 6 and send data to Computer for analysis
28. THE END.

In some cases the chip can be prepared for imaging by stopping the wash flow, leaving the reaction chamber filled with clear buffer liquid, and performing excitation and reading through the liquid-filled chamber 6. In other cases, as illustrated in FIGS. 8H and FIG. 8H′ the reaction chamber is evacuated. In those cases, prior to imaging, it is preferred to produce a flow of desiccating air through the narrow flow gap (G) reaction chamber by introducing pressurized drying air in the vicinity of opto-sensor 5, by a connection not shown.

The above sequence ensures that no air enters the reaction chamber, once analyte has been pumped through it, by capture of air upstream of the reaction chamber. Thus while providing relaxed tolerances, i.e. permitting a level of dimensional and processing tolerances, highly accurate assay results are made possible while using a cassette that is simple and relatively inexpensive to manufacture and use. To explain in more detail, the protocol is defined to ensure that following purging of all vias and analyte flow, no air is pushed through the reaction chamber. The design accommodates the metering tolerances of the stepper motor/lead screw/piston/pouch/pouch piercing/digital control combination. In the preferred implementation, employing the dimensions and relationships mentioned in the specification, the metering tolerance has been experimentally measured to be under 2.5 uL within the segment of the protocol that precedes detection reagent flow to the reaction chamber. A 5 uL value can be used to provide an additional safety margin.

The process of the assay may be summarized as follows, referring also to the just-mentioned sequence and FIGS. 2 and 8-8H:

With pipette, analyte is inserted into analyte chamber through septum 1.

Detection reagent valve 16 is opened and valves 18 and 17 are closed. Only via 35 is open.

Following advance of the external actuator to puncture the pouch 11 and advance buffer liquid, the liquid is displaced to fill detection reagent chamber 14 to liquefy dried detection reagent (Ab) and trigger reagent control Opto-sensor 13 in detection reagent discharge passage 35.

Valve 16 is closed and valve 17 opened.

Reagent fluid is pumped into dye (tag) reagent chamber 15 with a volume defined to ensure that no dye reagent can enter into manifold 32. As pumping tolerances are 5 uL in the preferred embodiment, an air bubble of undefined size within that tolerance is held in chamber 15 and via 34.

Valve 17 is then closed and valve 18 opened. Valve 16 stays closed.

Buffer fluid is then pumped into wash channel 37 and into bubble trap 8 and may enter via 38 within the tolerance of pre-defined volume control such that no fluid enters into analyte vias (channels) 40 or 42.

Valve 18 is then closed. Valve 17 stays closed.

Valves 16, 17 and 18 are closed.

The analyte is then pumped to fill bubble trap 9, metered from opto-sensor 5 and through RC 6 according to the capture protocol. Analyte pumping is then stopped.

After the predetermined volume of analyte has been pumped, and following a wash phase as noted in step 17 above, valve 16 is then opened and pump 12 pushes buffer fluid to displace fluidized detection reagent, e.g., antibody in chamber 14. Fluidized detection reagent pushes ahead of it air that is within opto-sensor 13 and the top portion 35a of via 35. That forces fluid in via 39 to enter bubble trap 8 and complete the fill of bubble trap 8 if needed. It should be noted that bubble trap 8 is then filled completely and will capture any incoming gas from opto-sensor 13 and top of via 35 as well as any air in via 34 and gas that may out-gas from the liquids during their heating.

The cassette has been flushed of air and primed and is then ready to complete the assay.

It thus can be seen that the above protocol ensures that all air is purged or captured from the network of chambers and vias to prevent air passage through the reaction chamber following the passage of the analyte.

Referring to FIG. 7-7E the pouch is made and filled according to standard processes. It is installed in cavity 10, bonded in place with double sided adhesive tape such as 3M #9889. It is pressed on the crown of the pouch and may be retained with a clip or bonded or held with an ultrasonic crown.

As the piston P is moved to contact and deform the back of the cup 11A of the pouch, the lid 11B—made of 0.001 inch soft aluminum, as specified above, deforms to conform to the base of the cavity and bond against the continuous annular surface of the cavity (while leaving the relatively narrow exit passage unobstructed to permit flow from the piercing member 46, to be described). When sufficient force is applied by the piston—typically 250 to 2000 grams—the metal of the lid 11B flows to conform to the depressed central region where the pyramid-shaped awl 30 is located until the lid material impales itself on the awl, piercing itself to form an exit passage. The awl has a relatively narrow gutter 46 shown in FIGS. 7A-E surrounding the awl, which guides the flow to the bottom of the depressed cavity such that it will fill from the bottom, chasing all air out toward the relatively narrow outlet located at the top end of the depression, see FIGS. 7A-7C, showing the orientation of the assembly relative to vertical during use.

The pouch capsule is deformed by the piston and resists deformation such that the piston needs to exert a force typically between 250 and 2000 grams to propel liquid as the piston advances.

When the piston P is retracted possibly as much as 50 micrometers, the back of the pouch is forced to retract due to limited elastic properties of the cup wall and behaves for such movement as a suction pump, see FIG. 7E. In the preferred embodiment a 1 micrometer piston displacement causes a flow of approximately 0.2 micro-liter in either direction.

Another aspect of the implementation of the figures concerns cyclic oscillation, with net forward flow per cycle, of liquids through the low-profile reaction chamber. This helps achieve spot-to spot consistency of reaction on each transverse array of replicate spots in the reaction chamber 6. Referring to FIGS. 9-9C, 10, and 10A the system employs a liquid displacement pump, either pump 3 or 12, actuated by an external actuator according to its predetermined automatic pumping protocol. The cassette reaction chamber 6, with its inlet passage 48 and discharge passage 50, is constructed to conduct a reaction related to an assay by pumped flow of liquids with Reynolds number less than 1 over the capture surface, through the discharge passage 50 to a waste receptacle 19. The control system drives the pump in a predetermined cyclic operation with forward pumping and backward pumping phases in repeating cycles, see the examples of FIGS. 10 and 10A. The forward pumping phase is arranged to produce flow through the reaction chamber out the discharge end, through the discharge passage 50 to the waste receptacle 19. The backward pumping phase is arranged to produce backward flow, withdrawing liquid from the inlet end of the reaction chamber 6 and the discharge passage 50, without exposing the capture surface to air. The net flow per cycle according to the predetermined protocol is in the forward direction out of the discharge end, with substantial gravity discharge of liquid to the waste receptacle 19 and refreshed flow over the capture surface. Each reaction step of the assay employs a large number of such cycles of operation, typically in excess of 10.

The implementation has the following further features.

In one case the pump for the oscillating flow is the reagent pump 12, comprising the deformable container (pouch) having a wall that is resilient within at least a limited elastic range, the container arranged to be compressed by motion of the external actuator and, for backward pumping for a limited distance following forward pumping, the elastic recovery of the wall within its elastic range, to a less deformed position, as permitted by speed-controlled retraction of the external actuator, serves to increase the volume of the container (pouch) to draw liquid backward into the container, resulting in drawing liquid backward in the reaction chamber, through the inlet 48. In the specific case illustrated, the container is the blister pack of FIGS. 7-7E, the body of the blister pack being defined by a formed sheet that comprises a layer of aluminum subject to permanent deformation by compression of the body by the external actuator to reduce the volume of the blister pack and displace liquid forward from it, the blister pack containing a pre-packaged buffer liquid.

In another case, the pump is a rolling diaphragm pump, associated with a storage chamber. In the particular case of the figures, the storage chamber is the analyte chamber 2 associated with analyte rolling diaphragm displacement pump 3, the analyte chamber associated with a septum 1 for insertion of analyte into the chamber 2 as a preliminary step prior to conducting the assay with the cassette.

As shown in FIGS. 9 and 9B, an upwardly extending discharge passage 50 at the discharge end of the reaction chamber 6 terminates at a point of gravity fall of discharge into waste chamber 19. The discharge passage 50 is sized to contain at least a volume equal to the volume of liquid drawn backward through the inlet during the rearward flow phase of each pumping cycle, so that the backward flow occurs without exposing the reaction chamber to air. In practice the passage 50 is oversized to provide a safety margin.

The reaction chamber and total back flow per cycle determined by the pumping protocol are of substantially the same volume. In implementations the volume may be about 4 ul. The forward flow may be approximately double that volume, providing progressive flows of fresh reagent. The net forward flow characterizes the assay as a flow-through type of assay.

The reaction chamber of the embodiment is defined by a capture surface bearing an array of deposits of capture reagent, and an opposed window spaced apart by a flow gap of between about 50 and 300 micron (in the specific example, 100 micron), the width and length of the capture surface and opposed window being substantially greater than the flow gap, the inlet passage and the discharge passage being of substantially different flow cross-section profile from that of the reaction chamber. In implementations constructed to economize on the use of the analyte liquid, the depth of the gap between the capture surface and opposed window may be of the order of 100 micron, their width being about 4 mm and their length about 12 mm, carrying one set of replicate spots in each row across the capture surface. In other implementations, the width may be wider and the capture surface may, for instance, have multiple sets of replicate spots in each row across its width.

The predetermined pumping protocol provides a forward flow to backward flow volume ratio in the range of 3/1 to 3/2. In implementation of this feature, the ratio may be about 2/1, and in some implementations the flows in both directions may be at the same volumetric flow rates, the forward flow phase lasting twice as long as the backward flow phase, see FIG. 10, for example, or the flows in both directions may be of the same duration, the forward flow phase having twice the volumetric flow rate of the backward flow phase, see FIG. 10A, for example.

A method is provided of conducting an assay employing the cassette according to this aspect, which may employ one or more of any of the above-enumerated features. It is particularly useful in cases employing an array of replicate spots, e.g., 4 to 8 spots of capture reagent arranged transversely to the direction of flow, which results in high consistency of result from spot to spot.

Referring to FIGS. 12, external heating assembly 101 is constructed for face-to-face heat transfer relationship with the cassette back surface at a respective cavity in the molded cassette body. Assembly 101 is part of control unit 60 of FIG. 12 under control of a temperature sensor responsive to the temperate in the reaction chamber. It raises the liquids to approximately uniform temperature, preferably 37 degrees Celsius.

In operation, the substantial angle to horizontal at which the cassette is held (angle α, FIG. 12) places waste vent 20 at the top of the cassette. The cassette may be inserted into control unit 60 and liquid sample is injected into analyte (sample) reservoir 2 after which the cover is closed. The fluid reagent pouch 11 in cavity 10 is pierced by the awl 30, to release the liquid. By pumping of liquid, air within the cassette is expelled through the reaction chamber 6, and waste receptacle 19, to exit through vent filter 20. All stages of operation are controlled electronically e.g., by system controller 60.

Performance of an assay is initiated by system controller 60 activating the pistons of pumps 3 and 12 and valves 16, 17 and 18 in controlled sequence.

Reading the result of an assay, in the case of employing fluorescent label or tag in the assay, involves exciting the tagged molecules with radiation of a selected wavelength by the system of FIG. 12C and measuring the level of excited fluorescence from the fluorescent tags that have bound to the capture surface, e.g. to detection ligand antibody molecules which themselves have attached to the analyte molecules, which themselves have attached to the ligand receptors (capture molecules) on the capture surface.

The level of fluorescence is represented by an aggregate of the signal level of the image pixels from the region of the image captured of the reaction chamber. Each region of interest is associated with the known location where a specific assay reaction has taken place. The processing instrument (system controller) 60 may have an integral reading station that captures an image of the entire biochip for analysis. Reader station 60 of the figure has a reading system 64 that captures an image of the reaction chamber for further processing, see FIGS. 12B and 12C. Alternatively, a reading station separated from the processing station may be preferred.

Referring to FIGS. 1 and FIGS. 2-5, it has been found that residual detection reagent molecules in the bubble removal system 8 may agglomerate with molecules of tag reagent that subsequently flow through the system. Such agglomerations may subsequently enter reaction chamber 6 and interfere with consistency of readings during the detection phase of the assay.

A vigorous washing of the bubble removal system between detection and tag reagent flows, by employing cyclic oscillation with net wash liquid advance, preferably with substantially different flow rates in the forward and rearward movement, e.g., similar to that for the wash flow in FIG. 10A, has been found to remove residual detection molecules from the bubble removal system to overcome this effect.

The effect is also avoided by a revision of the cassette, to reroute the tag reagent to avoid its flow through the bubble removal system that may contain detection reagent. The forms of cassettes of FIGS. 1′ and 1″ achieve this. In the cassette form of FIG. 1′, the tag reagent flows through passage 34′ from reagent storage 15′ directly to a “T” connection with inlet passage 48 to the reaction chamber. In the cassette form of FIG. 1″ the tag reagent flows in passage 34″ from reagent storage 15′ to an independent third bubble removal system 8′, then to the T connection for flow to the reaction chamber.

FIGS. 2′ to 5′ show an implementation of the FIG. 1′ form of cassette while FIGS. 8′ to 8H′ illustrate its states during use.

Valve 17′ controls flow of buffer liquid from supply passage 21 to an enlarged and curved tag reagent storage channel 15′.

A porous foam or frit insert 15A′ laden with dried tag reagent in manner previously described is disposed in channel 15′ as shown in FIGS. 2′ and 4′. Channel 15′ is curved in plan view, somewhat in the shape of a banana, efficiently utilizing the cassette foot print. Flow cross-sections of channel 15′ taken transversely to flow axis A, are all rectangular with squared edges and constant depth. This enables insert 15A′ to be fabricated by die-cutting from a sheet of foam or frit of constant thickness with square edges to fit closely within the channel, see FIG. 6′. Tag reagent delivery channel 34′ extends from storage channel 15′ to the opto sensor cavity 5 where it effectively forms a “T” connection with flow from bubble trap 9 and the reaction chamber inlet channel 48. Channels 15′ and 34′ are filled by operating buffer pump 12 a predetermined number of stepper motor steps to fill tag reagent chamber 15′ and delivery passage 34′ within the error tolerance of the pumping system, i.e. to a level between points A′ and B′ of FIG. 8A′. It is found with some reagent systems that the air segment that thus remains at the end of channel 34′ due to the error range of pumping does not impair labeling of the complexes in the reaction chamber. This is believed to be due to high binding coefficients between selected sets of detection and tag (dye) reagent. In other cases, in which such air may not be tolerated, the third air bubble removal system 8′ of FIG. 1″ is added to remove this air segment before the tag reagent reaches the inlet to the reaction chamber.

The implementation of FIGS. 2′-5′ can be operated with a flow protocol defined in FIG. 10A′, see the flow ratios, flow duration and, in the cases of backward-forward-net advance mixing cycles, by the number N of cycles specified. The reactivity of typical label (dye) reagents is such that no mixing cycles are necessary during label flow for reaction in the reaction chamber. Mixing can be added where the labels selected have lower reactivity.

For performing washes, the flow velocities employed are much faster than reaction velocities. For example the protocol of FIG. 10A′ defines wash velocities substantially 4 times or more greater than reagent velocities. It has also been found effective for washing following detection and label reactions, to employ relatively short duration negative flows and additional actuator dwell periods between negative and positive flows as shown in FIG. 10A.

Because less critical to the assay, the wash step between analyte run and detection reagent run may be less than half the duration of the other washes and need not involve back and forth mixing, the object in this case mainly being to provide clear definition between the analyte run and detection run phases.

The details of one or more implementations of the aspects and features of the disclosure have been set forth in the description and accompanying drawings. The aspects and features of this disclosure may be varied or employed in other cassette arrangements and perform other functions, including those not employing biological substances. For instance a pouch may be formed of layers of synthetic resin without use of a metal layer, and have appropriate recovery properties, when deformed, to provide a return force to act as a suction pump for the limited backward flows. A set of substantially parallel flow sub channels may be formed by a nest of side-by-side tubes or tube-like features to produce the plug-like flow, and they may define a hydrophilic surface for carrying dried reagent. Such structure may be molded or extruded of hydrophobic material and post-treated to be hydrophilic. The solid that immobilizes the capture reagent in the reactive chamber may be of forms other than a planar surface and the capture reagent may be in forms other than deposited spots. An assay reagent in liquid form may be introduced and stored in a cassette and subjected to the plug flow and mixing actions described. Instead of radiation-stimulated fluorescence, cassettes may be based on other detection schemes, for instance luminescence or electrochemical luminescence. Other variations, objects, and advantages will be apparent from the description and drawings, and from the claims.

1. A method of storing desiccated biological molecules or similar reagent on a flow-dividing material filling the transverse cross-section and a substantial length of a storage passage within a cassette, including so selecting and sizing the material in the passage that in the presence of a liquefying agent that can form reagent liquid with the desiccated reagent, a displacing flow of a viscosity different from that of the reagent liquid, due to the flow-dividing effect of the material, produces plug-like flow of the reagent liquid.

2. The method of claim 1, wherein the flow dividing material is a porous material.

3. The method of claim 2, wherein the porous material is an open cell foam or a frit.

4. The method of claim 1, wherein the flow dividing material defines a multiplicity of parallel flow sub-channels.

5. The method of claim 1, wherein the material is preformed into sets of segments sized to fit in respective sections of a passage of the cassette and, for a particular assay that has been selected, a set of the segments receive selected reagents for the respective assay, which are dried and stored, ready to be installed in the respective passages in the cassette when required.

6. A method of producing a flow of a reagent liquid, comprising storing a reagent according to the method of claim 1, and subjecting flow through the flow-dividing material to forward and backward oscillations during its forward progress out of the storage passage.

7. A cassette having a reaction chamber constructed to conduct a reaction related to an assay, the cassette including buffer liquid storage, a buffer liquid displacement pump for displacing liquids at Reynolds number less than 1 through a passage system, the passage system including a buffer delivery passage for buffer liquid displaced by the pump, a reagent storage passage having extended length in the direction of flow relative to the maximum dimension of its transverse cross-section and capable of storing a liquid reagent of viscosity relatively higher than the viscosity of the buffer liquid, and a relatively small flow cross-section reagent delivery passage leading from the reagent storage passage to the reaction chamber, the buffer delivery passage arranged to deliver displaced buffer liquid into the reagent storage passage, wherein a substantial majority of the length of the reagent storage passage is filled with flow-dividing porous material, or is defined by a multiplicity of substantially parallel flow sub-channels, the porous material or sub-channels providing a multiplicity of paths along the reagent storage passage of transverse cross sections that are small relative to the over-all transverse cross section of the reagent storage passage and distributed across its cross-section and along its length to establish, in response to the pump's displacement of buffer liquid, plug-like flow of the relatively higher viscosity reagent liquid from the reagent storage passage into the reagent delivery passage.

8. The cassette of claim 7, wherein the cassette further comprises a positive displacement pump arranged to push liquid through the multiplicity of paths defined by the porous material or sub-channels within the reagent storage passage.

9. The cassette of claim 7, wherein the surface of the porous material or the sub-channels is hydrophilic.

10. The cassette of claim 7, wherein the surface of the porous material or the sub-channels is hydrophilic for supporting reagent material dried thereon, and has a releasable property for the reagent when contacted with liquid, a dried layer of reagent material disposed on the hydrophilic surface, exposed to contact with buffer liquid flowing into the reagent passage to enable the reagent material to be liquefied in situ, to create the relatively viscous reagent liquid that is subject to the plug-like flow.

11. The cassette of claim 7, wherein the substantial majority of the length of the reagent storage passage is filled with the porous material and the size of pores of the porous material is between about 5 to 200 micron.

12. The cassette of claim 11 in which the size of the pores is selected from the group of materials comprising material having a nominal pore size of 30 micron, with variation plus or minus 50%, and material having a nominal pore size of 100 micron, with variation plus or minus 20% .

13. The cassette of claim 7, wherein the reagent storage passage is of rectangular transverse cross-section and porous material of sheet-form open cell foam or frit closely fits the cross-section over more than half of the length of the reagent storage passage.

14. The cassette of claim 13, wherein the reagent storage passage containing porous material is a channel of substantially constant transverse cross-section, of length at least about 60 mm and channel width and depth of about 2 mm and 0.6 mm, respectively.

15. The cassette of claim 7, wherein the substantial majority of the length of the reagent storage passage is filled with flow-dividing porous material.

16. The cassette of claim 15 in which the porous material comprises hydrophilic frit formed of polyethylene.

17. The cassette of claim 15 in which the porous material comprises hydrophilic melamine foam.

18. The cassette of claim 15 in which the porous material comprises hydrophilic polyurethane foam.

19. The cassette of claim 15 in which the porous material comprises porous nitrocellulose in treated state that enables release of deposited bio-material when contacted with liquid.

20. The cassette of claim 19 in which the treated state comprises coating on the nitrocellulose of a mediating substance such as a blocker protein.

21. The cassette of claim 15 in which the porous material comprises hydrophilic polystyrene foam in treated state that enables release of deposited bio-material when contacted with liquid.

22. The cassette of claim 7, wherein a substantial majority of the length of the reagent storage passage is defined by a multiplicity of substantially parallel flow sub-channels each having transverse cross-section dimensions less than 1 mm.

23. The cassette of claim 22 in which the transverse cross-section dimensions are less than about 0.5 mm.

24. The cassette of claim 23 in which the transverse cross-section dimensions are in the range of about 0.5 mm and 0.01 mm.

25. The cassette of claim 7, wherein the reagent storage passage is defined by a multiplicity of sub-channels formed by a molded or extruded resin bearing a hydrophilic surface.

26. The cassette of claim 7, wherein the reagent is a detection reagent.

27. The cassette of claim 26, wherein the detection reagent is an antibody or antigen.

28. The cassette of claim 7, wherein the reagent is a label reagent.

29. The cassette of claim 28, wherein the label reagent includes a fluorescent dye.

30. A method of delivering liquid reagent to a reaction chamber via a reagent delivery passage by displacing reagent liquid from a storage passage by a buffer liquid of viscosity that is low relative to the viscosity of the reagent liquid, comprising
(a) providing a cassette according to claim 7, wherein either the reagent has been provided in liquid form to the cassette, or has been stored in the cassette in dried form and subsequently liquefied to provide the reagent liquid; and
(b) operating a buffer pump to establish plug-like flow of the relatively higher viscosity reagent liquid from the reagent storage passage into the reagent delivery passage.

31. The method of claim 30 in which the reagent has been stored in the cassette in dried form as a dried layer on a hydrophilic surface of a porous flow-dividing material within the reagent storage passage, or on a hydrophilic surface of a multiplicity of parallel flow sub-channels forming the reagent storage passage, initially operating a buffer displacement pump in manner to introduce buffer liquid into the reagent storage passage to liquefy the reagent, the resulting reagent liquid remaining stored in the cassette, and subsequently operating the buffer pump to pump buffer liquid into the porous material or multiplicity of sub-channels to establish plug-like flow of the relatively higher viscosity reagent liquid from the reagent passage into the reagent delivery passage for supply to the reaction chamber.

32. The method of claim 31 in which the dried reagent layer comprises detection or label bio-material.

33. The method of claim 31, including employing backward and forward oscillations of the liquid with net forward advance, to effectively provide flow to the reaction chamber.

34. A cassette having a liquid storage, pumping and passage system and a reaction chamber, the cassette constructed to conduct a reaction related to an assay by flow of liquids with Reynolds number less than 1 through the system and over a capture surface within the reaction chamber, and constructed to exclude air from reaching the reaction chamber until completion of reactions of the assay, the storage, pumping and passage system including:
an analyte chamber constructed to receive an analyte-containing liquid, an analyte displacement pump for displacing analyte-containing liquid through the system and reaction chamber,
a first buoyancy bubble trap arranged to be filled by displaced analyte-containing liquid, and
a passage leading from the first bubble trap to the reaction chamber; the storage, pumping and passage system also including:
pre-filled buffer liquid storage,
a buffer liquid displacement pump for displacing liquids through the system and the reaction chamber,
a buffer delivery passage for buffer liquid displaced by the buffer liquid displacement pump,
a reagent storage passage containing a dried reagent and capable of storing the reagent in liquid form when it is liquefied,
a reagent delivery passage leading from the reagent storage passage for flow to the reaction chamber, the buffer delivery passage arranged to deliver displaced buffer liquid into the reagent passage and, alternatively, through a wash passage for flow to the reaction chamber, and
a second buoyancy bubble trap arranged to be filled by displaced buffer liquid and arranged for flow from the reagent store passage to flow through it the discharge of the second bubble trap connected to flow through the first bubble trap (9) and thence to the reaction chamber.

35. The cassette of claim 34, wherein the flow from the wash passage also flows through the second bubble trap, thence through the first bubble trap to the reaction chamber.

36. The cassette of claim 34, wherein a passage is associated with a detector for the air-liquid interface of liquid entering the passage, enabling an external pump and associated control unit responsive to the detector to fill that passage to a predetermined point.

37. The cassette of claim 34, wherein a passage is arranged to fill the second bubble trap by operating the buffer displacement pump over a predetermined pumping volume that results in leaving an indeterminate volume of un-displaced air upstream of the first bubble trap, within a range determined by the predetermined range of flow volume error of the buffer displacement pump, the first bubble trap sized to receive and store said un-displaced air.

38. The cassette of claim 34, wherein there are at least two passages connectible to be filled by the buffer pump by respective operations of the pump, leaving air in each of the respective passages each of these passages arranged to enable its flow to pass through the second bubble trap, the second bubble trap sized to hold the maximum volume of air that may remain within each passage connected to it together with air from liquids passing through the bubble trap.

39. The cassette of claim 38, wherein the at least two passages merge into a common passage leading to the second bubble trap without passing through a valve.

40. The cassette of claim 34, wherein the first bubble trap has an air holding volume of about 10 microliters, and the second bubble trap has an air holding volume of about 50 microliters.

41. The cassette of claim 34, wherein the buffer displacement pump comprises a blister pack containing buffer liquid, a surface of the blister pack being deflectable by an actuator (P) external of the cassette to progressively displace liquid from the blister pack.

42. The cassette of claim 34, wherein the analyte displacement pump comprises a rolling elastic diaphragm pump.

43. A method of conducting an assay employing the cassette of any claim 34, the cassette having storage passages for both a detection reagent and a label reagent.

44. A method of conducting an assay with a cassette having the components indicated below and operated substantially according to the following protocol:
1. Insert analyte liquid in analyte chamber 2 via septum 1
2. Close valves 18 & 17 (wash passage 37 and tag reagent chamber 15)
3. Open valve 16 (detection reagent chamber 14)
4. Operate buffer pump 12 (rotating stepper motor, depressing piston of buffer pump) to
5. Impale pouch 11 on pyramid 30 to release buffer liquid
6. Continue operation of buffer pump 12, (depressing piston and compressing pouch 11) to fill detection reagent passage 14 until
7. Opto-sensor 13 triggers
8. Close valve 16
9. Open valve 17
10. Operate buffer pump 12 a predetermined number of stepper motor steps to fill tag reagent chamber 15 and slightly beyond within error tolerance. Stop.
11. Close valve 17
12. Open valve 18
13. Operate buffer pump 12 a predetermined number of stepper motor steps to fill wash passage 37 and bubble trap 8 and slightly beyond within error tolerance. Stop
14. Close valve 18
15. Operate analyte pump 3 to fill bubble trap 9 until Opto-sensor 5 triggers
16. Continue operation of analyte pump 3 to flow analyte liquid through reaction chamber 6 per protocol.
17. Open valve 18 and operate buffer pump 12 to wash reaction chamber 6 with buffer liquid per protocol
18. Close valve 18
19. Open valve 16 and operate buffer pump 12 to flow detection reagent through reaction chamber 6 per protocol
20. Close valve 16
21. Open valve 18 and operate buffer pump 12 to wash reaction chamber 6 with buffer liquid per protocol
22. Close valve 18
23. Open valve 17 and operate buffer pump 12 to flow tag reagent through reaction chamber 6 per protocol
24. Close valve 17
25. Open valve 18 and operate buffer pump 12 to wash reaction chamber 6 per protocol
26. Prepare chip for imaging.
27. Image the biochip through the window of the reaction chamber 6 and send data to computer for analysis
28. THE END.

45. The cassette of claim 34, wherein the buffer pump is in the form of a blister pack filled with buffer fluid, the blister pack having a cover and a volume-defining blister body, the body capable of progressive collapse between a driving piston (P) external of the cassette and an anvil surface to produce a positive liquid displacement pumping action to force liquid forward into the passage system.

46. The cassette of claim 45 in which the cover is adhered and sealed about a piercing device disposed on the anvil surface, and capable of being deformed to be pierced by the device for releasing liquid to a channel associated with the piercing device.

47. The cassette of claim 46, wherein the cover is a metal foil comprised of aluminum of thickness of about 0.001 inch.

48. The cassette of claim 45, wherein the body of the blister pack is capable of elastic recovery upon retraction of the piston sufficient to produce a negative liquid pumping action to draw liquid back within the passage system.

49. The cassette of claim 48, in which the body of the blister pack is defined by a draw-formed sheet that comprises a layer of aluminum, the blister pack subject to permanent deformation when compressed to reduce the blister pack volume and displace liquid from the blister pack forward into the passage system of the cassette in a forward pumping action, for a backward pumping action for a limited distance following forward pumping action, residual elastic recovery of the permanently deformed aluminum wall of the blister body to a less deformed position permitted by progressive retraction of the piston serving as the driving force to increase the volume of the blister pack, drawing liquid back into the blister pack.

50. The cassette of claim 49, in which the blister pack has a volume of about 2 ml and the elastic recovery permitted by progressive retraction of the actuator produces an increase in the volume of the previously deformed blister pack by at least 3 microliters.

51. A method of pumping liquid within a cassette employing a deformable metal blister pack including progressively compressing and permanently deforming a body of the blister pack with an actuator (P) to displace liquid forward, and periodically reversing the movement of the actuator and allowing limited elastic recovery of the permanently deformed blister body to maintain contact with the rearward moving actuator, the increase in volume of the deformed blister pack drawing liquid back into the blister pack.

52. The method of claim 51, in which the blister pack is constructed according to claim 45.

53. A system for conducting an assay employing a cassette having a liquid displacement pump actuated by an external actuator (P) according to a predetermined automatic pumping protocol, the cassette having a liquid passage system and a reaction chamber having inlet and discharge ends associated respectively with inlet and discharge passages, the cassette constructed to conduct a reaction related to an assay by pumped flow of liquids with Reynolds number less than 1 through the passage system and over a capture surface within the reaction chamber, through the discharge passage to a waste receptacle from which there is no return, wherein; a control system responsive to the pumping protocol drives the pump in a cyclic operation with forward pumping and backward pumping phases in repeating cycles, the forward pumping phase arranged to produce flow through the reaction chamber out the discharge end, through the discharge passage to the waste receptacle and the backward pumping phase arranged to produce backward flow withdrawing liquid from the inlet end of the reaction chamber and the discharge passage, the net flow per cycle according to the predetermined protocol being in the forward direction out of the discharge end for substantial discharge of liquid to the waste receptacle, and replenishing flow of the liquid to which the capture surface is exposed.

54. The system of claim 53, in which the pump comprises a deformable container having a wall that is resilient within at least a limited elastic range, the container arranged to be compressed by motion of an external actuator (P) and, for backward pumping for a limited distance following forward pumping, the recovery of the wall within its elastic range, to a less deformed position as permitted by retraction of the actuator (P), serving to increase the volume of the container to draw liquid backward into the container, resulting in drawing liquid backward through the inlet of the reaction chamber.

55. The system of claim 54, in which the container comprises a blister pack, the body of the blister pack (which may be defined by a formed sheet that comprises a layer of aluminum) subject to permanent deformation by compression of the body by the external actuator (P) to reduce the volume of the blister pack and displace liquid forward from it.

56. The system of claim 54, wherein the container contains a pre-packaged buffer liquid.

57. The system of claim 53, wherein the pump is a rolling diaphragm pump associated with a storage chamber.

58. The system of claim 57 in which, wherein the storage chamber is an analyte chamber, the analyte chamber associated with a septum for insertion of analyte fluid into the chamber as a preliminary step prior to conducting the assay with the cassette.

59. The system of claim 53, wherein an upwardly extending discharge passage at the discharge end of the reaction chamber terminates at a point of gravity fall of discharge into a waste chamber, the discharge passage sized to contain at least a volume equal to the volume of liquid drawn backward through the inlet during the rearward flow phase of a pumping cycle, so that the backward flow occurs without exposing the reaction chamber to air.

60. The system of claim 53, wherein the reaction chamber and total back flow per cycle determined by the pumping protocol are of substantially the same volume.

61. The system of claim 60, wherein the volume is about 4 microliters.

62. The system of claim 53, wherein the reaction chamber is defined by a capture surface and opposed window spaced apart by a flow gap G of between about 50 and 300 micron, the width (W) and length (L) of the capture surface and opposed window being substantially greater than the dimension (G) of the flow gap, the inlet passage and the discharge passage being of substantially different flow cross-section profile from that of the reaction chamber.

63. The system of claim 62, wherein the depth (G) of the gap between the capture surface and opposed window is of the order of 100 micron, their width (W) being about 4 mm and their length (L) about 12 mm.

64. A pumping control system for causing flow of liquid at Reynolds number less that 1 through a reaction chamber to progressively expose an assay capture surface to the liquid, wherein the control system is responsive to a predetermined pumping protocol to drive a pump in a cyclic operation with forward and backward pumping phases in repeating cycles, the forward pumping phase arranged to produce flow through the reaction chamber and out a discharge end, through a discharge passage to waste confinement and the backward pumping phase arranged to produce backward flow withdrawing liquid from an inlet end of the reaction chamber and from the discharge passage, the net flow per cycle according to the predetermined protocol being in the forward direction out of the discharge end for discharge of liquid to the waste confinement, and replenishing fresh liquid to the reaction chamber, preferably the pump located on a cassette that encloses the reaction chamber and preferably the waste confinement is a waste receptacle enclosed within the cassette.

65. The system of claim 53, wherein the predetermined pumping protocol provides a forward flow to backward flow volume ratio in the range of about 3/1 to 3/2.

66. The system of claim 65 in which the ratio is about 2/1.

67. The system of claim 53, wherein the flows in both directions are at about the same volumetric flow rates, the forward flow phase lasting longer, e.g., about twice as long as the backward flow phase.

68. The system of claim 53, wherein the flows in the two directions are different, e.g., the forward flow phase having about twice the volumetric flow rate of the backward flow phase.

69. The system of claim 53, wherein the cycles of operation include cycles having dwell phases during which the pump does not pump liquid.

70. The system of claim 53, wherein the control system for producing the set of protocol operations comprising the back and forth flows with net flow advance includes a machine readable medium having instructions stored therein which, when executed, cause the system to perform this set of operations in accordance with the pumping protocol.

71. The system of claim 70 including at least one linear pump actuator driven by a stepper motor to perform the operations.

72. The system of claim 71 in which the linear pump actuator is positioned to drive a pump within an assay cassette, the pump preferably operable with a rolling diaphragm action with at least limited elastic recovery.

73. The system of claim 53, wherein the cyclically operating pump propels the liquid through a conditioning region that conditions the liquid prior to the liquid reaching the reaction chamber.

74. The system of claim 73, wherein the conditioning region includes provisions for heat exchange with the pumped liquid.

75. The system of claim 74 adapted for biological assay in which the heat exchange is regulated to heat the liquid to about 37° C.

76. The system of claim 73, wherein the conditioning region includes a system for removing gas bubbles from the pumped liquid.

77. The system of claim 73 wherein the pumped liquid passes through a region in which a substance is exposed to the pumped liquid.

78. The system of claim 77, wherein the substance to be exposed to the liquid is a dried substance distributed through the body of flow-dividing open cell foam or frit through which the pumped liquid is directed.

79. The system of claim 78, wherein the open cell foam or frit fills a reagent storage passage of length in the flow direction greater than at least 10 times the largest transverse dimension of the storage passage.

80. The system of claim 79, wherein the reagent storage passage is of rectangular cross-section transverse to the direction of flow and porous material of sheet-form open cell foam or frit fills the cross section of the passage over more than half of the length of the reagent storage passage.

81. The system of claim 79 wherein the storage passage has an open plenum volume at each end into which liquid displaced through the porous material enters.

82. A method of conducting an assay employing the cassette or system of claim 53.

83. The method of claim 82, conducted in manner to cause liquid containing analyte to move in forward and backward directions over the capture surface with net forward flow to the waste receptacle.

84. The method of claim 83, in which the capture surface comprises an array of replicate spots (S) of a given capture reagent arranged transversely to the axis of flow over the capture surface.

85. The method of claim 82 wherein, following pumping of liquid containing analyte to flow over the capture surface in the reaction chamber, the pumping is stopped and a buffer pump is actuated to force buffer liquid to displace a reagent liquid in a reagent storage passage to cause reagent liquid to flow through the reaction chamber.

86. The method of claim 85, wherein the buffer pump is actuated to cause liquid containing reagent to move in forward and backward directions in the reagent storage passage to produce mixing while causing net forward flow of liquid through a reagent delivery passage and the reaction chamber to the waste receptacle.

87. The method of claim 85 conducted with a cassette having a reagent storage passage containing flow-dividing porous material that provides a multiplicity of interlaced flow paths along the reagent storage passage, the flow paths being open to one another and of transverse flow cross-sections that are small relative to the over-all transverse cross-section of the reagent storage passage and the flowpaths distributed across the transverse cross-section of the storage passage and along its length.

88. The method of claim 87 in which the porous material comprises open cell foam or frit.

89. The method of claim 87, conducted with a cassette in which a desiccated reagent is distributed through the porous material.

90. The method of claim 88, wherein the presence of the porous material is effective to produce substantially a plug-like flow of reagent liquid from the reagent storage passage into a reagent delivery passage in response to forward pumping of a buffer liquid.

91. An assay cassette having flows limited to Reynolds number NRₑ less than 1, comprising a flow mixing channel extending in a general direction and connected to supply reagent to a reaction chamber, the channel filled for a substantial length with a three-dimensional mass of open cell foam or frit to cause fluid flowing in the channel to split into a multiplicity of relatively small flows along differing interlaced flow paths, the paths having flow components transverse to the general direction of the channel along with flow components in the direction of the flow channel, the individual flow paths varying in direction relative to one another and being open to interchange with each other effective to produce a substantially chaotic mixing effect upon liquid flowing into and through the open cell foam or frit material, the output of the channel arranged to supply flow of the thus-mixed liquid to the reaction chamber.

92. The cassette of claim 91 wherein, within the reaction chamber, there is a solid capture surface carrying an array of replicate spots (S) of capture reagent for capturing a reagent carried in the flow from the channel.

93. The cassette of claim 91, wherein surface within the foam or frit is hydrophilic and a desiccated biological agent is supported on the surface, exposed to be hydrated by flow of liquid through the foam or frit.

94. The cassette of claim 93 in which the channel is connected to receive flow of a buffer liquid of viscosity substantially less than the viscosity of reagent exiting the foam or frit material.

95. The cassette of claim 92, wherein the size of pores of the open cell foam or frit is between about 5 to 200 micron.

96. The cassette of claim 95, wherein the size of the pores is selected from the group of open cell foam or frit materials having a nominal pore size of 30 micron, with variation plus or minus 50%, and materials having a nominal pore size of 100 micron, with variation plus or minus 20%.

97. The cassette of claim 92, wherein the flow mixing channel has a transverse cross-section and porous material of sheet-form foam or frit closely fits the transverse cross-section over substantially more than half of the length of the flow mixing channel.

98. The cassette of claim 97 in which the channel is of substantially constant transverse cross-section, of length at least about 60 mm and channel width and depth of about 2 mm and 0.6 mm, respectively.

99. A cassette having a flow-through assay reaction chamber constructed for back and forth liquid mixing in a narrow gap (G) over an array of capture agent (S), with net flow advance to waste confinement produced by a reversible pump, preferably operable with rolling diaphragm action with at least limited elastic recovery, that advances sample or buffer liquids through conditioning paths before reaching the reaction chamber, the pump producing accurate flow control, liquid conditioning, e.g. liquefying dry reagent from internal surfaces of flow-dividing material, heating, and air bubble removal, as well as replenishment of reagent while accomplishing mixing within the flow-through reaction chamber; in the case of the pumping of buffer liquid: preferably lower viscosity buffer liquid is arranged to propel higher viscosity reagent liquid, the flow-dividing storage material preserving the concentration of the reagent; a blister pack on the cassette containing buffer liquid acts as the reversible pump in producing accurate forward and backward flows with the net flow advance; and cascaded bubble traps on the cassette render the system tolerant of minor pumping error during cassette priming.

100. A cassette having a liquid storage, pumping and passage system and a reaction chamber, the cassette constructed to conduct a reaction related to an assay by flow of liquids with Reynolds number less than 1 through the system and over a capture surface within the reaction chamber, the cassette constructed to be stored with air-filled passages prior to use, but, after initial entry of analyte-containing liquid into the reaction chamber, constructed to exclude air from reaching the reaction chamber until completion of reactions of the assay, the storage, pumping and passage system including:
an analyte chamber constructed to receive an analyte-containing liquid, an analyte displacement pump for displacing analyte-containing liquid through the system and reaction chamber,
a first buoyancy bubble trap arranged to be filled by displaced analyte-containing liquid, and
a passage leading from the first bubble trap to the reaction chamber; the storage, pumping and passage system also including:
pre-filled buffer liquid storage,
a buffer liquid displacement pump for displacing liquids through the system and the reaction chamber, the buffer liquid displacement pump having a predetermined range of flow volume error,
a buffer delivery passage for buffer liquid displaced by the buffer liquid displacement pump,
a reagent storage passage containing a dried reagent and capable of storing the reagent in liquid form when it is liquified,
a reagent delivery passage leading from the reagent storage passage for flow to the reaction chamber, the buffer delivery passage arranged to deliver displaced buffer liquid into the reagent passage and, alternatively, through a wash passage for flow to the reaction chamber, and
a second buoyancy bubble trap arranged to be filled by displaced buffer liquid;
the reagent storage passage adapted to be filled by the buffer pump by activation for a predetermined pumping volume that results in leaving an indeterminate volume of un-displaced air in the buffer delivery passage of volume within a range determined by the predetermined range of flow volume error of the buffer displacement pump,
the second buoyancy bubble trap sized to hold the maximum volume of air that can remain in the reagent storage passage due to the buffer pump operating for the predetermined pumping volume at the lowest flow volume within its predetermined range of flow volume error together with air released by liquid flowing through the second bubble trap,
the discharge of the second bubble trap connected to flow through the first bubble trap and thence to the reaction chamber, the first bubble trap sized to hold residual air residing between the first and second bubble traps together with air released from the flow of liquids through it.

101. A cassette, system or method in which a reagent storage channel, defined by surfaces, through which liquid flows is filled over a predetermined length with flow-dividing material, the material defining surfaces throughout the material on which dried reagent is deposited, the surfaces throughout this material in aggregate having surface area at least 10 fold greater than the aggregate surface area of the surfaces defining the portion of the channel that is filled by the material.

102. A cassette, system or method in which flow-dividing storage material has internal surfaces carrying a deposit of dried reagent.

103. A cassette, system or method in which the flow-dividing material has length in the direction of flow at least 10 times the width of the material and a width that is at least twice the thickness of the material.

104. The cassette, system or method of claim 103 in which the material is of sheet form of thickness less than 1 mm.

105. A method of priming a cassette passage of known volume with liquid comprising providing in the cassette a pump in the form of a blister pack capable of rolling diaphragm action and containing buffer liquid, and with a linear actuator, displacing the back of the blister pack a predetermined distance inward to displace buffer liquid to fill the known volume.

106. The method of claim 105 in which the linear actuator is driven by a stepper motor and the predetermined distance is controlled by advancing the stepper motor a predetermined number of steps.

107. A method of conducting a flow assay by advancing liquid through a narrow flow gap (G) reaction chamber including the step of providing a storage channel containing open cell foam or frit on the internal surfaces of which reside a predetermined layer of dried reagent, introducing liquid to the storage chamber to liquefy the reagent to a known reagent concentration and advancing the liquid of known reagent concentration through the flow gap (G).

108. The method of claim 107, wherein the reagent is advanced by directing a displacing flow of lower viscosity buffer liquid into the open cell foam or frit.

109. The method of claim 107, wherein advancing of the flow is periodic.

110. The method of claim 109 in which the flow is caused to move rearwardly periodically in manner preserving net forward advance of the flow through the gap.
